(19) United States
(12) Patent Application Publication
(10) Pub. No.: US 2025/0226397 A1
(43) Pub. Date: Jul. 10, 2025

(54) COMPOSITE CATHODE ACTIVE MATERIAL, AND CATHODE AND LITHIUM SECONDARY BATTERY CONTAINING THE COMPOSITE CATHODE ACTIVE MATERIAL

(71) Applicant: Samsung SDI Co., Ltd., Yongin-si (KR)

(72) Inventors: Kyungho YOON, Suwon-si (KR); Junhwan KU, Suwon-si (KR); Bokkyu CHOI, Suwon-si (KR); Dongil KANG, Suwon-si (KR); Yonggun LEE, Suwon-si (KR)

(21) Appl. No.: 19/014,793

(22) Filed: Jan. 9, 2025

(30) Foreign Application Priority Data
Jan. 9, 2024 (KR) 10-2024-0003640
Dec. 2, 2024 (KR) 10-2024-0176720

(51) Int. Cl. H01M 4/36; C01G 53/42; H01M 4/02; H01M 4/525; H01M 4/587; H01M 10/052; H01M 10/0561

(52) U.S. Cl. CPC H01M 4/366; C01G 53/42; H01M 4/525; H01M 4/587; H01M 10/052; H01M 10/0561; C01P 2002/52; C01P 2004/03; C01P 2004/80; C01P 2006/40; H01M 2004/021; H01M 2004/028; H01M 2300/008

(57) ABSTRACT

A composite cathode active material including a plurality of particles, the particles including a lithium transition metal oxide, and a coating layer arranged on at least a portion of the surface of the particles. The coating layer includes a linear carbon-based material and a solid electrolyte, and a length of the linear carbon-based material is 1,000 μm or more.

### CROSS-REFERENCE TO RELATED APPLICATION

This application claims priority to Korean Patent Application No. 10-2024-0003640, filed on Jan. 9, 2024, and Korean Patent Application No. 10-2024-0176720, filed on Dec. 2, 2024, filed in the Korean Intellectual Property Office, and all the benefits accruing therefrom under 35 U.S.C. § 119, the disclosure of which in their entirety are incorporated by reference herein.

### BACKGROUND

### 1. Field

The disclosure relates to a composite cathode active material, and a cathode and a lithium secondary battery including the composite cathode active material.

### 2. Description of the Related Art

The development of lithium secondary batteries with high energy density as well as miniaturization and weight reduction is needed to meet the never ending demand for miniaturization and high performance of various electronic devices. Accordingly, the continuing development of high-capacity lithium secondary batteries is important and ongoing.

In order to achieve lithium secondary batteries with the above performance and design specifications, the development of cathode active materials with high capacity is essential to that goal. Conventional cathode active materials generally exhibit poor lifespan characteristics and poor thermal stability as a result of side reactions.

### SUMMARY

Provided is a novel composite cathode active material having improved electronic conductivity and ionic conductivity to provide high capacity and relatively fast charging characteristics.

Provided is a cathode including the composite cathode active material.

Provided is a lithium secondary battery including the cathode.

Additional aspects will be set forth in part in the description which follows and, in part, will be apparent from the description, or may be learned by practice of the presented embodiments of the disclosure.

According to an aspect of the disclosure, a composite cathode active material includes a plurality of particles, the plurality of particles including a lithium transition metal oxide, and a coating layer arranged on at least a portion of the surface of the particles,
wherein the coating layer includes a linear carbon-based material and a solid electrolyte, and a length of the linear carbon-based material is 1,000 μm or more.

According to an aspect of the disclosure, a composite cathode active material includes a plurality of particles, the particles including a first lithium transition metal oxide and a second lithium transition metal oxide,
wherein the first lithium transition metal oxide is a large-diameter lithium transition metal oxide, and the second lithium transition metal oxide is a small-diameter lithium transition metal oxide, the first lithium transition metal oxide having a particle diameter greater than that of the second lithium transition metal oxide.

According to another aspect of the disclosure, a cathode includes
a cathode current collector, and
a cathode active material layer arranged on the cathode current collector and including the composite cathode active material as described herein.

According to another aspect of the disclosure, a lithium secondary battery includes the cathode.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a cross-sectional schematic diagram of a composite cathode active material according to an embodiment;

FIGS. 2, 3, and 4 are scanning electron microscope images of a composite cathode active material according to an embodiment; and

FIGS. 5 to 9 are each a cross-sectional representation of a lithium secondary battery according to an embodiment.

### DETAILED DESCRIPTION

Reference will now be made in detail to embodiments, examples of which are illustrated in the accompanying drawings, wherein like reference numerals refer to like elements throughout the specification. In this regard, the present embodiments may have different forms and should not be construed as being limited to the descriptions set forth herein. Accordingly, the embodiments are merely described below, by referring to the figures, to explain aspects.

Various embodiments are illustrated in the attached drawings. However, the present inventive idea may be embodied in many different forms and should not be construed as being limited to the embodiments described herein. Rather, these examples are provided so that the disclosure will be thorough and complete, and will fully convey the scope of the present inventive idea to those skilled in the art. Identical drawing symbols indicate identical components.

When a component is referred to as being “on” another component, it may be understood that the component may be directly on the other component, or that other components may be arranged therebetween. In contrast, when a component is referred to as being “directly on” another component, no other components are arranged therebetween.

The terminology used herein is for the purpose of describing particular embodiments only and is not intended to be limiting. As used herein, the singular forms (“a”, “an,” and “the” are intended to include the plural forms, including “at least one,” unless the content clearly indicates otherwise. Therefore, reference to “an” element in a claim followed by reference to “the” element is inclusive of one element as well as a plurality of the elements.

The terms “first,” “second,” “third,” etc. may be used herein to describe various components, ingredients, regions, layers, and/or zones, but these components, ingredients, regions, layers, and/or zones should not be limited by these terms. These terms are used only to distinguish one component, ingredient, region, layer, or zone from another component, ingredient, region, layer, or zone. Accordingly, a first component, ingredient, region, layer, or zone described below may be referred as a second component, ingredient, region, layer, or zone without departing from the teachings of the present specification.

The terminology used herein is for the purpose of describing particular embodiments only and is not intended to limit the inventive idea. As used herein, the singular form is intended to include the plural form including “at least one,” unless the context clearly dictates otherwise. “At least one” should not be construed as being limited to the singular.

As used herein, the term “and/or” includes any and all combinations of one or more of the listed items. The terms “comprise” and/or “comprising” as used in the detailed description specify the presence of stated features, regions, integers, steps, operations, components, and/or ingredients, but do not preclude the presence or addition of one or more other features, regions, integers, steps, operations, components, ingredients, and/or groups thereof.

Unless otherwise defined, all terms (including technical and scientific terms) used herein have the same meaning as commonly understood by one of ordinary skill in the art to which the disclosure belongs. It will also be understood that terms defined in commonly used dictionaries should be interpreted to have a meaning consistent with their meaning within the context of the relevant art and the disclosure, and not in an idealized or overly formal sense.

Exemplary embodiments are described herein with reference to cross-sectional views which are schematic diagrams of idealized embodiments. Likewise, variations in the illustrated shapes may be expected, for example as a result of manufacturing techniques and/or tolerances. Accordingly, the embodiments described herein should not be construed as being limited to the specific shapes of regions as illustrated herein, but should include deviations in shapes resulting from, for example, manufacturing processes. For example, a region depicted or described as being flat may typically have rough and/or non-linear features. Moreover, the sharply drawn angles may be rounded. Accordingly, the regions depicted in the drawings are schematic in nature, and their shapes are not intended to depict the precise shape of the regions and are not intended to limit the scope of the present claims.

“Group” means a group of the Periodic Table of Elements according to the International Union of Pure and Applied Chemistry (“IUPAC”) Group 1 to 18 classification system.

The term “particle diameter” as used herein refers to an average diameter when the particle is spherical and refers to an average major axis length when the particle is non-spherical. The particle diameter may be measured by using a particle size analyzer (PSA). The term “particle diameter” as used herein refers to, for example, an average particle diameter. The term “average particle diameter” as used herein refers to, for example, a median particle diameter, D50.

D50 refers to a particle size corresponding to a 50% cumulative volume calculated from particles having the smallest particle size in a particle size distribution measured by a laser diffraction method.

D90 refers to a particle size corresponding to a 90% cumulative volume calculated from particles having the smallest particle size in a particle size distribution measured by a laser diffraction method.

D10 refers to a particle size corresponding to a 10% cumulative volume calculated from the smallest particle size in a particle size distribution measured by a laser diffraction method.

The term “metal” as used herein may include both metal and metalloid such as silicon and germanium, in an elemental or ionic state.

The term “alloy” as used herein means a mixture of two or more metals.

The term “electrode active material” means an electrode material capable of undergoing lithiation and delithiation.

The term “cathode active material” as used herein means a cathode material capable of undergoing lithiation and delithiation.

The term “anode active material” as used herein means an anode material capable of undergoing lithiation and delithiation.

The terms “lithiation” and “lithiate” as used herein mean a process of adding lithium to an electrode active material.

The terms “delithiation” and “delithiate” as used herein mean a process of removing lithium from an electrode active material.

The terms “charging” and “charge” as used herein mean a process of providing electrochemical energy to a battery.

The terms “discharging” and “discharge” as used herein mean a process of removing electrochemical energy from a battery.

The terms “positive electrode” and “cathode” mean an electrode at which electrochemical reduction and lithiation occur during a discharge process.

The terms “negative electrode” and “anode” mean an electrode at which electrochemical oxidation and delithiation occur during a discharge process.

Although specific embodiments have been described, alternatives, modifications, variations, improvements, and substantial equivalents which are not currently anticipated or cannot be anticipated may occur to the applicant or those skilled in the art. Accordingly, the appended claims, as filed and as amended, are intended to encompass all such alternatives, modifications, variations, improvements and substantial equivalents.

Hereinafter, a composite cathode active material according to exemplary embodiments, and a cathode and a lithium secondary battery including the composite cathode active material are described in more detail. At times, a theoretical (hypothesis) or technical reason or basis for excellent effects provided by the composite cathode active material according to an embodiment may be provided, however, such technical reasons or hypothesis are merely stated and provided to assist in the understanding of the described cathode active material or cathode, are such reasons or explanations are not intended to limit the inventive concept or the claims in any way.

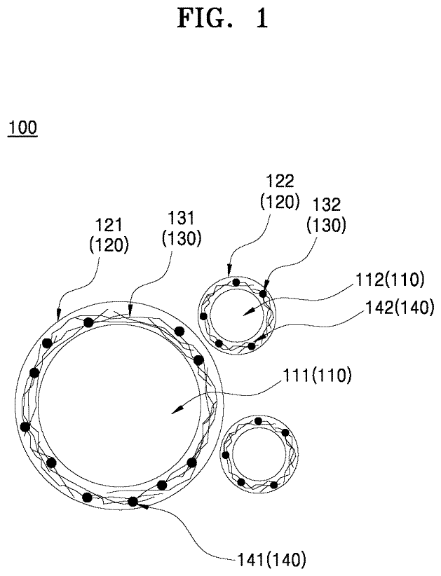

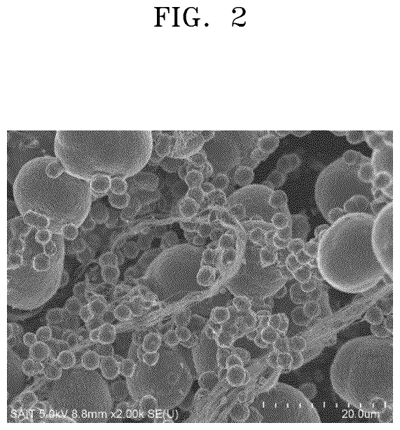

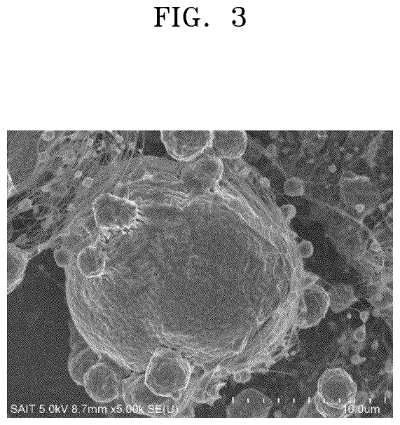

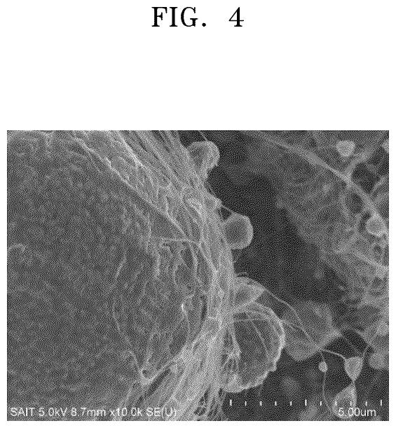

FIG. 1 is a cross-sectional schematic representation of a composite cathode active material according to an embodiment. FIGS. 2, 3, and 4 are respective scanning electron microscope images of a composite cathode active material according to an embodiment.

Referring to FIGS. 1 to 4, the composite cathode active material may include: a particle 110 including a lithium transition metal oxide; and a coating layer 120 arranged on at least a portion of the surface of the particle 110. The coating layer 120 includes a linear carbon-based material 130 and a solid electrolyte 140, and a length of the linear carbon-based material may be 1,000 micrometers (μm) or more.

For example, the length of the linear carbon-based material may be 1,200 μm or more, 1,400 μm or more, 1,600 μm or more, 1,800 μm or more, or 2,000 μm or more. For example, the length of the linear carbon-based material may be in a range of about 1,200 μm to about 10,000 μm, about 1,400 μm to about 10,000 μm, about 1,600 μm to about 10,000 μm, about 1,800 μm to about 10,000 μm, about 2,000 μm to about 10,000 μm, about 1,000 μm to about 5,000 μm, or about 1,500 μm to about 5,000 μm.

In the composite cathode active material 100, a linear carbon-based material 130 having a length of 1,000 μm or more and a solid electrolyte 140 in the same coating layer 120 may be included on the surface of a particle 110, The particle 110 includes a lithium transition metal oxide so that the electronic conductivity and ion conductivity of the composite cathode active material 100, and thereby improving the interparticle characteristics of the composite cathode active material 100. As electron and ion movements between the particles 110 in the composite cathode active material 100 are facilitated or enhanced, a lithium secondary battery including the composite cathode active material 100 not only may have an increased capacity, but also may have improved fast charging and high efficiency characteristics.

According to an embodiment, a diameter of the linear carbon-based material 130 may be in a range of about 50 nm to about 100 nm.

According to an embodiment, the linear carbon-based material may be a single-walled carbon nanotube (SWCNT), a double-walled carbon nanotube (DWCNT), a multi-walled carbon nanotube (MWCNT), or a combination thereof.

According to an embodiment, the solid electrolyte may be a sulfide-based solid electrolyte, and the sulfide-based solid electrolyte may be one or more selected from Li₂S—P₂S₅, Li₂S—P₂S₅—LiX, where X is a halogen element, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ, where m and n are each a positive number, and Z is one of Ge, Zn, and Ga, Li₂S—GeS₂, Li₂S—SiS₂—Li₃PO₄, Li₂S—SiS₂-LiₚMO_{q}, where p and q are each a positive number, and M is one of P, Si, Ge, B, Al, Ga, and In, Li₇₋ₓPS₆₋ₓClₓ, where 0≤x≤2, Li₇₋ₓPS₆₋ₓBrₓ, where 0≤x≤2, and Li₇₋ₓPS₆₋ₓIₓ, where 0≤x≤2.

According to an embodiment, the sulfide-based solid electrolyte may include an argyrodite-type solid electrolyte, and the argyrodite-type solid electrolyte may include one or more selected from Li₆PS₅Cl, Li₆PS₅Br, and Li₆PS₅I.

According to an embodiment, the density of the Argyrodite-type solid electrolyte may be in a range of about 1.5 g/cc to about 2.0 g/cc.

According to an embodiment, a particle diameter (D50) of the solid electrolyte may be 1 μm or less. For example, the particle diameter (D50) of the solid electrolyte may be in a range of about 0.1 μm to about 1 μm.

According to an embodiment, the sum of the weight of the solid electrolyte and the weight of the linear carbon-based material may be in a range of about 1 wt % to about 20 wt % based on the total weight of the composite cathode active material. For example, the sum of the weight of the solid electrolyte and the weight of the linear carbon-based material, based on the total weight of the composite cathode active material may be in a range of about 1 wt % to about 15 wt %, about 1 wt % to about 10 wt %, about 1 wt % to about 8 wt %, or about 2 wt % to about 8 wt %.

According to an embodiment, a weight ratio of the linear carbon-based material to the solid electrolyte may be in a range of about 1:10 to about 10:1. For example, the weight ratio of the linear carbon-based material to the solid electrolyte may be in a range of about 1:5 to about 5:1, about 1:3 to about 3:1, or about 1:2 to about 2:1.

According to an embodiment, the lithium transition metal oxide may include a first lithium transition metal oxide and a second lithium transition metal oxide, and the first lithium transition metal oxide may be a large-diameter lithium transition metal oxide, and the second lithium transition metal oxide may be, for example, a small-diameter lithium transition metal oxide. The first lithium transition metal oxide will have a particle diameter that is greater than the second lithium transition metal oxide.

A first coating layer 121 including a first linear carbon-based material 131 and a first solid electrolyte 141 may be formed on at least a portion of the surface of a first particle 111 including a first lithium transition metal oxide having a large diameter. A second coating layer 122 including a second linear carbon-based material 132 and a second solid electrolyte 142 may be formed on at least a portion of the surface of the second particle 112 including a second lithium transition metal oxide having a small diameter. In this case, a composite cathode active material including a second particle 112 including a second lithium transition metal oxide having a small diameter may be arranged in the pores of a composite cathode active material including a first lithium transition metal oxide particle 111 having a large diameter. When small-diameter particles are arranged in the pores or voids between the large-diameter particles, the ionic conductivity and/or electronic conductivity of a cathode including the composite cathode active material may be improved. Additionally, the energy density of the cathode including the composite cathode active material may be improved. As a result, the energy density and cycle characteristics of a lithium battery including the composite cathode active material may be improved.

The lithium transition metal oxide may have a bimodal particle diameter distribution. For example, the composite cathode active material may have a bimodal particle diameter distribution having two peaks obtained by using a particle size analyzer (PSA) or the like. The bimodal particle diameter distribution may have a first peak corresponding to the first lithium transition metal oxide and a second peak corresponding to the second lithium transition metal oxide.

A particle diameter ratio of the first lithium transition metal oxide to the second lithium transition metal oxide may be, for example, about 2:1 to about 10:1, about 3:1 to about 10:1, about 3:1 to about 8:1, about 3:1 to about 6:1, or about 3:1 to about 5:1. When the particle diameter ratio of the first lithium transition metal oxide to the second lithium transition metal oxide is within the ranges above, the energy density and cycle characteristics of a lithium battery including the composite cathode active material may be further improved.

The particle diameter of the first lithium transition metal oxide may be in a range, for example, about 10 μm to about 20 μm, about 10 μm to about 18 μm, or about 10 μm to about 15 μm. The particle diameter of the first lithium transition metal oxide may be, for example, a median particle diameter (D50).

The particle diameter of the second lithium transition metal oxide may be, for example, in a range of about 1 μm to less than about 5 μm, or about 1 μm to about 4 μm. The particle diameter of the first lithium transition metal oxide may be, for example, a median particle diameter (D50). When the average particle diameter of the first lithium transition metal oxide and the second lithium transition metal oxide is within the ranges above, the energy density and/or cycle characteristics of a lithium battery including the composite cathode active material may be further improved.

The particle diameter of the first lithium transition metal oxide and the second lithium transition metal oxide may be measured by using a measuring device using such as a laser diffraction method or a dynamic light scattering method, for example. The particle diameter may be measured by, for example, using a laser scattering particle size distribution meter (for example, Horiba LA-920), and may be a value of the median particle diameter (D50) corresponding to 50 vol % when accumulated from the smallest particle size in the particle size distribution. Alternatively, the particle diameters of the first lithium transition metal oxide and the second lithium transition metal oxide may be measured from scanning electron microscope (SEM) images or optical microscopes.

The weight ratio of the first lithium transition metal oxide to the second lithium transition metal oxide may be, for example, in a range of about 90:10 to about 60:40, about 85:15 to about 65:35, about 80:20 to about 65:35, or about 75:25 to about 65:35. When the first lithium transition metal oxide and the second lithium transition metal oxide have a weight ratio within the ranges above, the energy density and/or cycle characteristics of a lithium battery including the composite cathode active material may be further improved.

A specific surface area of the composite cathode active material may be, for example, 0.8 m²/g or less, 0.5 m²/g or less, or 0.3 m²/g or less. The specific surface area of the composite cathode active material may be, for example, in a range of about 0.1 m²/g to about 0.8 m²/g, about 0.1 m²/g to about 0.5 m²/g, or about 0.1 m²/g to about 0.3 m²/g. When the composite cathode active material has a low specific surface area within the ranges above, side reactions with the electrolyte may be suppressed. As a result, the cycle characteristics of a lithium battery including the composite cathode active material having a reduced specific surface area may be improved. The specific surface area of the cathode active material including secondary particles formed from a plurality of primary particles may be, for example, 1 m²/g or more. When the cathode active material including secondary particles has an increased specific surface area, side reactions with the electrolyte may be increased. As a result, the cycle characteristics of a lithium battery including the composite cathode active material having an increased specific surface area may deteriorate.

According to an embodiment, the coating layer may further include a second carbon-based material. The second carbon-based material may include, for example, a carbon nanofiber, a carbon nanotube, or a combination thereof. The carbon nanotube may include, for example, a primary carbon nanotube structure, a secondary carbon nanotube structure formed by agglomeration of a plurality of particles of the primary carbon nanotube structure, or a combination thereof.

The primary carbon nanotube structure may be one carbon nanotube unit. The carbon nanotube unit may include a graphite sheet in a cylindrical shape with a nano-sized diameter and may have a sp² bond structure. According to a bending angle and a structure of the graphite sheet, the characteristics of conductors or semiconductors may be improved. The carbon nanotube unit may be classified, depending on the number of bonds as including a wall, e.g., a single-walled carbon nanotube (SWCNT), a double-walled carbon nanotube (DWCNT), and a multi-walled carbon nanotube (MWCNT), and the like. As the wall thickness of the carbon nanotube unit is small, the resistance may decrease.

The primary carbon nanotube structure may include, for example, a single-walled carbon nanotube (SWCNT), a double-walled carbon nanotube (DWCNT), a multi-walled carbon nanotube (MWCNT), or a combination thereof. The diameter of the primary carbon nanotube structure may be, for example, 1 nm or more, or 2 nm or more. The diameter of the primary carbon nanotube structure may be, for example, 20 nm or less, or 10 nm or less. The diameter of the primary carbon nanotube structure may be, for example, in a range of about 1 nm to about 20 nm, about 1 nm to about 15 nm, or about 1 nm to about 10 nm. The length of the primary carbon nanotube structure may be, for example, 100 nm or more, or 200 nm or more. The length of the primary carbon nanotube structure may be, for example, 2 μm or less, 1 μm or less, 500 nm or less, or 300 nm or less. The length of the primary carbon nanotube structure may be, for example, in a range of about 100 nm to about 2 μm, about 100 nm to about 1 μm, about 100 nm to about 500 nm, about 100 nm to about 400 nm, about 100 nm to about 300 nm, or about 200 nm to about 300 nm. The diameter and length of the primary carbon nanotube structure may be measured from a scanning electron microscope (SEM) image or a transmission electron microscope (TEM) image. Alternatively, the diameter and/or length of the primary carbon nanotube structure may be measured by a laser diffraction method.

The secondary carbon nanotube structure may be a structure formed by assembling the primary carbon nanotube structure in whole or in part to form a bundle-type or rope-type. The secondary carbon nanotube structure may include, for example, a bundle-type carbon nanotube, a rope-type carbon nanotube, or a combination thereof. The diameter of the secondary carbon nanotube structure may be, for example, 2 nm or more, or 3 nm or more. The diameter of the secondary carbon nanotube structure may be, for example, 50 nm or less, 30 nm or less, 20 nm or less, or 10 nm or less. The diameter of the secondary carbon nanotube structure may be, for example, in a range of about 2 nm to about 50 nm, about 2 nm to about 30 nm, or about 2 nm to about 20 nm.

The length of the secondary carbon nanotube structure may be, for example, 500 nm or more, 700 nm or more, 1 μm or more, or 10 μm or more. The length of the secondary carbon nanotube structure may be, for example, 1000 μm or less, 500 μm or less, or 100 μm or less. The length of the secondary carbon nanotube structure may be, for example, in a range of about 500 nm to about 1000 μm, about 500 nm to about 500 μm, about 500 nm to about 200 μm, about 500 nm to about 100 μm, or about 500 nm to about 50 μm. The diameter and length of the secondary carbon nanotube structure may be measured from a scanning electron microscope (SEM) image or an optical microscope image. Alternatively, the diameter and/or length of the secondary carbon nanotube structure may be measured by a laser diffraction method.

The secondary carbon nanotube structure may be used in the preparation of the composite cathode active material by, for example, being dispersed in a solvent or the like to be converted into the primary carbon nanotube structure.

The content of the second carbon-based material may be, for example, in a range of about 5 wt % to about 95 wt %, about 10 wt % to about 90 wt %, about 20 wt % to about 80 wt %, about 30 wt % to about 70 wt %, or about 40 wt % to about 60 wt %, based on the total weight of the linear carbon-based material and the second carbon-based material. When the composite cathode active material includes a linear carbon-based material and a second carbon-based material within the ranges above, a conduction path may be further effectively secured in the composite cathode active material, and thus the internal resistance of the composite cathode active material may be further reduced. As a result, the cycle characteristics of a lithium battery including the composite cathode active material may be further improved. The content of the second carbon-based material may be, for example, in a range of about 0.01 wt % to about 1 wt %, about 0.01 wt % to about 0.8 wt %, about 0.01 wt % to about 0.5 wt %, about 0.01 wt % to about 0.3 wt %, or about 0.01 wt % to about 0.1 wt % of the total weight of the composite cathode active material. When the composite cathode active material includes the second carbon-based material within the ranges above, a conduction path may be secured in the composite cathode active material, and thus the internal resistance of the composite cathode active material may be further reduced. As a result, the cycle characteristics of a lithium battery including the composite cathode active material may be further improved.

Since the carbon-based material may be derived from, for example, a graphene matrix, the carbon-based material may have a relatively low density and high porosity, compared to a conventional carbon-based material derived from a graphite-based material. A d002 interplanar distance of the carbon-based material may be, for example, 3.38 Å or more, 3.40 Å or more, 3.45 Å or more, 3.50 Å or more, 3.60 Å or more, 3.80 Å or more, or 4.00 Å or more. The d002 interplanar distance of the carbon-based material included in the coating layer 120 may be, for example, in a range of about 3.38 Å to about 4.0 Å, about 3.38 Å to about 3.8 Å, about 3.38 Å to about 3.6 Å, about 3.38 Å to about 3.5 Å, or about 3.38 Å to about 3.45 Å. In contrast, the d002 interplanar distance of a conventional carbon-based material derived from a graphite-based material may be, for example, 3.38 Å or less, or 3.35 Å to 3.38 Å.

For example, the coating layer 120 may further include a first metal oxide. Since the first metal oxide has voltage resistance, the deterioration of the lithium transition metal oxide included in the core may be prevented during charging and discharging at a high voltage. The coating layer 120 may include, for example, two different types of the first metal oxide. As a result, the high-temperature cycle characteristics of a lithium battery including the above-described composite cathode active material may be improved. The content of the coating layer 120 may be, for example, in a range of about 0.1 wt % to about 5 wt %, about 0.1 wt % to about 4 wt %, about 0.1 wt % to about 3 wt %, about 0.1 wt % to about 2.5 wt %, about 0.1 wt % to about 2 wt %, or about 0.1 wt % to about 1.5 wt % of the total weight of the composite cathode active material. The content of the first metal oxide may be, for example, in a range of about 0.06 wt % to about 3 wt %, about 0.06 wt % to about 2.4 wt %, about 0.06 wt % to about 1.8 wt %, about 0.06 wt % to about 1.5 wt %, about 0.06 wt % to about 1.2 wt %, or about 0.06 wt % to about 0.9 wt % of the total weight of the composite cathode active material.

The first metal oxide may include a metal, and the metal may be, for example one or more selected from Al, Nb, Mg, Sc, Ti, Zr, V, W, Mn, Fe, Co, Pd, Cu, Ag, Zn, Sb, and Se. The first metal oxide may be represented by Formula MₐO_{b} (where 0<a≤3, 0<c≤4, and when a is 1, 2, or 3, c is an integer). For example, the first metal oxide may be, for example, one or more selected from Al₂O_{z} (where 0<z<3), NbOₓ (where 0<x<2.5), MgOₓ (where 0<x<1), Sc₂O_{z} (where 0<z<3), TiO_{y} (where 0<y<2), ZrO_{y} (where 0<y<2), V₂O_{z} (where 0<z<3), WO_{y} (where 0<y<2), MnO_{y} (where 0<y<2), Fe₂O_{z} (where 0<z<3), Co₃O_{w}(where 0<w<4), PdOₓ (where 0<x<1), CuOₓ (where 0<x<1), AgOₓ (where 0<x<1), ZnOₓ (where 0<x<1), Sb₂O_{z} (where 0<z<3), and SeO_{y} (where 0<y<2). By arranging the first metal oxide in a matrix of the carbon-based material, the uniformity of the coating layer 120 arranged on the particle 110 including the lithium metal oxide may be improved, and voltage resistance of the composite cathode active material may be further improved.

The coating layer 120 may further include one or more second metal oxide represented by Formula MₐO_{c} (where 0<a≤3, 0<c≤4, and when a is 1, 2, or 3, c is an integer). M is one or more metal selected from Groups 2 to 13, 15, and 16 of the Periodic Table of Elements. For example, the second metal oxide may include a metal identical to the first metal oxide, and a ratio of c to a, c/a, in the second metal oxide may be greater than a ratio of b to a, b/a, in the first metal oxide. For example, c/a>b/a.

The second metal oxide may be selected from, for example, Al₂O₃, NbO, NbO₂, Nb₂O₅, MgO, Sc₂O₃, TiO₂, ZrO₂, V₂O₃, WO₂, MnO₂, Fe₂O₃, Co₃O₄, PdO, CuO, AgO, ZnO, Sb₂O₃, and SeO₂. The first metal oxide may be, for example, a reduction product of the second metal oxide. The first metal oxide may be obtained by reducing some or all of the second metal oxide. Accordingly, the first metal oxide may have a lower oxygen content and a lower metal oxidation number than the second metal oxide. The coating layer 120 may include, for example, Al₂Oₓ (where 0<x<3) as the first metal oxide and Al₂O₃ as the second metal oxide.

The coating layer may include, for example, one or more selected from a first metal oxide and a second metal oxide, and the particle diameter of the one or more selected from the first metal oxide and the second metal oxide may be, for example, in a range of about 0.1 nm to about 100 nm, about 1 nm to about 50 nm, about 1 nm to about 30 nm, about 5 nm to about 30 nm, or about 10 nm to about 30 nm. When the first metal oxide and/or the second metal oxide has such a nano-scaled diameter, the first metal oxide and/or the second metal oxide may be further uniformly distributed in a matrix of the linear carbon-based material 130. When the particle diameter of the one or more of the first metal oxide and the second metal oxide is excessively increased, the thickness of the coating layer 120 may be increased, and thus the internal resistance of the composite anode active material may increase. When the particle diameter of the one or more of the first metal oxide and the second metal oxide is excessively reduced, the first metal oxide and/or the second metal oxide may not be uniformly dispersed.

The thickness of the coating layer 120 may be, for example, in a range of about 0.1 nm to about 1 μm, about 0.5 nm to about 500 nm, about 1 nm to about 100 nm, about 1 nm to about 50 nm, or about 1 nm to about 20 nm. The thickness of the coating layer 120 may be, for example, in a range of about 0.1 nm to about 1 μm, about 1 nm to about 500 nm, about 1 nm to about 300 nm, about 10 nm to about 200 nm, or about 10 nm to about 100 nm. When the thickness of the coating layer 120 is within the ranges above, the electronic conductivity of the cathode including the composite cathode active material may be further improved.

The coating layer 120 may have a single-layered structure, for example. The single-layered structure may have, for example, a first layer structure including the linear carbon-based material 120 and the solid electrolyte 130.

The coating layer 120 may be a dry coating layer manufactured by a dry process. The dry process may be, for example, mechanical milling, but is not necessarily limited thereto, and any method used as a dry process in the art may be used.

The content of the coating layer 120 may be, for example, in a range of about 1 wt % to about 20 wt %, about 1 wt % to about 15 wt %, about 1 wt % to about 10 wt %, or about 2 wt % to about 10 wt %, based on the total weight of the composite cathode active material. When the content of the coating layer 120 included in the composite cathode active material is within the ranges above, the cycle characteristics of a lithium battery including the composite cathode active material may be further improved.

The coating layer 120 formed on at least a portion of a surface of the particle 110 may be formed, for example, by coating the linear carbon-based material 130 and the solid electrolyte 140 on the particle 110 including a lithium transition metal oxide by using a Resonance Acoustic Mixer or the like. For example, the solid electrolyte 140 may be arranged in a matrix of the linear carbon-based material 130.

According to an embodiment, the particle 110 may include a lithium transition metal oxide represented by Formulae 1 to 8:

LiₐCoₓM_{y}O_{2-b}A_{b} Formula 1

wherein, in Formula 1,
1.0≤a≤1.2, 0≤b≤0.2, 0.9≤x≤1, 0≤y≤0.1, and x+y=1,
M may be manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof,
A may be F, S, Cl, Br, or a combination thereof;

LiₐNiₓCO_{y}M_{z}O_{2-b}A_{b} Formula 2

wherein, in Formula 2,
1.0≤a≤1.2, 0≤b≤0.2, 0.8≤x<1, 0≤y≤0.3, 0<z≤0.3, and x+y+z=1,
M may be manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof, and
A may be F, S, Cl, Br, or a combination thereof;

LiNiₓCo_{y}Mn_{z}O₂ Formula 3

LiNiₓCo_{y}Al_{z}O₂ Formula 4
wherein, in Formulae 3 and 4, 0.8≤x≤0.95, 0≤y≤0.2, 0<z≤0.2, and x+y+z=1;

LiNiₓCo_{y}Mn_{z}Al_{w}O₂ Formula 5
wherein, in Formula 5, 0.8≤x≤0.95, 0≤y≤0.2, 0<z≤0.2, 0<w≤0.2, and x+y+z+w=1,

LiₐNiₓMn_{y}M′_{z}O_{2-b}A_{b} Formula 6
wherein, in Formula 6,
1.0≤a≤1.2, 0≤b≤0.2, 0<x≤0.3, 0.5≤y<1, 0<z≤0.3, and x+y+z=1,
M′ may be cobalt (Co), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof, and
A may be F, S, Cl, Br, or a combination thereof;

LiₐM1ₓM2_{y}PO_{4-b}X_{b} Formula 7
wherein, in Formula 7, 0.90≤a≤1.1, 0≤x≤0.9, 0≤y≤0.5, 0.9<x+y<1.1, and 0≤b≤2,
M1 may be chromium (Cr), manganese (Mn), iron (Fe), cobalt (Co), nickel (Ni), copper (Cu), zirconium (Zr), or a combination thereof, and
M2 may be magnesium (Mg), calcium (Ca), strontium (Sr), barium (Ba), titanium (Ti), zinc (Zn), boron (B), niobium (Nb), gallium (Ga), indium (In), molybdenum (Mo), tungsten (W), aluminum (Al), silicon (Si), chromium (Cr), vanadium (V), scandium (Sc), yttrium (Y), or a combination thereof, and X may be O, F, S, P, or a combination thereof; and

LiₐM3_{z}PO₄ Formula 8
wherein, in Formula 8, 0.90≤a≤1.1, and 0.9≤z≤1.1,
M3 may be chromium (Cr), manganese (Mn), iron (Fe), cobalt (Co), nickel (Ni), copper (Cu), zirconium (Zr), or a combination thereof.

According to an embodiment, a cathode may include: a cathode current collector; a cathode active material layer arranged on the cathode current collector and including the above-described composite cathode active material.

For example, when the cathode active material layer includes the above-described composite cathode active material, the electrical conductivity and ionic conductivity of the cathode active material layer may be improved, and accordingly, a lithium secondary battery including the cathode may have improved capacity and improved fast charging characteristics.

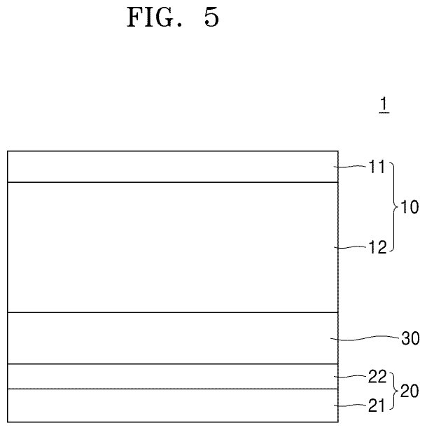

Referring to FIGS. 5 to 9, the cathode 10 may include a cathode current collector 11, and a cathode active material layer 12 arranged on the cathode current collector 11. The cathode active material layer 12 may include the above-described composite cathode active material.

According to an embodiment, the content of the composite cathode active material may be in a range of about 40 wt % to about 90 wt %, about 40 wt % to about 80 wt %, about 50 wt % to about 80 wt %, or about 50 wt % to about 70 wt %, based on the total weight of the cathode active material layer 12. When the content of the composite cathode active material is excessively reduced, the energy density of the secondary battery may be decreased. When the content of the composite cathode active material is excessively increased, the deterioration of the cathode may be accelerated due to changes in the volume of the cathode during charging and discharging. As a result, the cycle characteristics and performance of the secondary battery 1 may deteriorate.

In addition, the cathode active material layer 12 may additionally include a general cathode active material other than the above-described composite cathode active material.

As the general cathode active material, any lithium-containing metal oxide commonly used in the art may be used without limitation. For example, one or more selected from composite oxides of lithium and a metal selected from cobalt, manganese, nickel, and a combination thereof may be used, and a specific example thereof may be a compound represented by any one of the following formulae: LiₐA_{1-b}B_{b}D₂ (where 0.90≤a≤1, and 0≤b≤0.5); LiₐE_{1-b}B_{b}O_{2-c}D_{c} (where 0.90≤a≤1, 0≤b≤0.5, and 0≤c≤0.05); LiE_{2-b}B_{b}O_{4-c}D_{c} (where 0≤b≤0.5, and 0≤c≤0.05); LiₐNi_{1-b-c}Co_{b}B_{c}D_{α} (where 0.90≤a≤1, 0≤b≤0.5, 0≤c≤0.05, and 0<α≤2); LiₐNi_{1-b-c}Co_{b}B_{c}O_{2-α}F_{α} (where 0.90≤a≤1, 0≤b≤0.5, 0≤c≤0.05, and 0<α<2); LiₐNi_{1-b-c}Co_{b}B_{c}O_{2-α}F₂ (where 0.90≤a≤1, 0≤b≤0.5, 0≤c≤0.05, and 0<α<2); LiₐNi_{1-b-c}Mn_{b}B_{c}D_{α} (where 0.90≤a≤1, 0≤b≤0.5, 0≤c≤0.05, and 0<α≤2); LiₐNi_{1-b-c}Mn_{b}B_{c}O_{2-α}F_{α} (where 0.90≤a≤1, 0≤b≤0.5, 0≤c≤0.05, and 0<α<2); LiₐNi_{1-b-c}Mn_{b}B_{c}O_{2-α}F₂ (where 0.90≤a≤1, 0≤b≤0.5, 0≤c≤0.05, and 0<α<2); LiₐNi_{b}E_{c}G_{d}O₂ (where 0.90≤a≤1, 0≤b≤0.9, 0≤c≤0.5, and 0.001≤d≤0.1); LiₐNi_{b}Co_{c}Mn_{d}GₑO₂ (where 0.90≤a≤1, 0≤b≤0.9, 0≤c≤0.5, 0≤d≤50.5, and 0.001≤e≤0.1); LiₐNiG_{b}O₂ (where 0.90≤a≤1, and 0.001≤b≤0.1); LiₐCoG_{b}O₂ (where 0.90≤a≤1, and 0.001≤b≤0.1); LiₐMnG_{b}O₂ (where 0.90≤a≤1, and 0.001≤b≤0.1); LiₐMn₂G_{b}O₄ (where 0.90≤a≤1, and 0.001≤b≤0.1); QO₂; QS₂; LiQS₂; V₂O₅; LiV₂O₅; LiIO₂; LiNiVO₄; Li_{(3-f)}J₂(PO₄)₃ (where 0≤f≤2); Li_{(3-f)}Fe₂(PO₄)₃ (where 0≤f≤2); Li_{(3-f)}J₂(PO₄)₃ (where 0≤f≤2); Li_{(3-f)}Fe₂(PO₄)₃ (where 0≤f≤2); and LiFePO₄.

In the formulae above representing the above-described compounds, A may be Ni, Co, Mn, or a combination thereof; B may be Al, Ni, Co, Mn, Cr, Fe, Mg, Sr, V, a rare earth element, or a combination thereof; D may be O, F, S, P, or a combination thereof; E may be Co, Mn, or a combination thereof; F may be F, S, P, or a combination thereof; G may be Al, Cr, Mn, Fe, Mg, La, Ce, Sr, V, or a combination thereof; Q may be Ti, Mo, Mn, or a combination thereof; I may be Cr, V, Fe, Sc, Y, or a combination thereof; and J may be V, Cr, Mn, Co, Ni, Cu, or a combination thereof. A compound in which a coating layer is provided on the surface of the above-described compound may be used, and a mixture of the above-described compound and a compound provided with the coating layer may also be used. The coating layer provided on the surface of the above-described compound may include a coating element compound such as an oxide of a coating element, a hydroxide of a coating element, an oxyhydroxide of a coating element, an oxycarbonate of a coating element, or a hydroxycarbonate of a coating element. The compounds constituting this coating layer may be amorphous or crystalline. The coating element included in the coating layer may be Mg, Al, Co, K, Na, Ca, Si, Ti, V, Sn, Ge, Ga, B, As, Zr, or a mixture thereof. The method of forming the coating layer may be selected within a range that does not adversely affect the physical properties of the cathode active material. The coating method may be, for example, spray coating, dip coating, and the like. A more detailed description of the coating method will not be provided because it is well understood by those in the art.

For example, the cathode active material layer 12 may further include one or more selected from a binder and a conductive material.

The conductive material may be, for example, a carbon-based conductive material, a metal-based conductive material, or a combination thereof. The carbon-based conductive material may be, but is not limited to, graphite, carbon black, acetylene black, Ketjen black, carbon fiber, or a combination thereof, and any material used as a carbon-based conductive material in the art may be used. The metal-based conductive material may be, but is not limited to, metal powder, metal fiber, or a combination thereof, and a material used as a metal-based conductive material in the art may be used. The content of the conductive material included in the cathode active material layer 12 may be, for example, in a range of about 1 wt % to about 30 wt %, about 1 wt % to about 20 wt %, or about 1 wt % to about 10 wt % of the total weight of the cathode active material layer 12.

The binder may be, but is not limited to, styrene butadiene rubber (SBR), polytetrafluoroethylene, polyvinylidene fluoride, polyethylene, or the like, and any binder used in the art may be used. The content of the binder included in the cathode active material layer 12 may be, for example, in a range of about 1 wt % to about 10 wt % of the total weight of the cathode active material layer 12. The binder may be optional.

The cathode active material layer 12 may further include an additive such as a filler, a coating agent, a dispersant, an ion conductive aid, and the like in addition to the composite cathode active material, solid electrolyte, binder, and conductive material described above.

As a filler, a coating agent, a dispersant, an ion conductive aid, and the like that may be included in the cathode active material layer 12, known materials generally used in electrodes of all-solid-state secondary batteries may be used.

The cathode current collector 11 may be, for example, in the form of a plate or a foil, each consisting of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof. Use of the cathode current collector 11 may be optional. The thickness of the cathode current collector 11 may be, for example, in a range of about 1 μm to about 100 μm, about 1 μm to about 50 μm, about 5 μm to about 25 μm, or about 10 μm to about 20 μm.

The cathode current collector 11 may include, for example, a base film and a metal layer arranged on one side or both sides of the base film. The base film may comprise, for example, a polymer. The polymer may be, for example, a thermoplastic polymer. The polymer may include, for example, polyethylene terephthalate (PET), polyethylene (PE), polypropylene (PP), polybutylene terephthalate (PBT), polyimide (PI), or a combination thereof. The base film may be, for example, an insulator. When the base film includes an insulating thermoplastic polymer, the base film may soften or be liquefied when a short circuit occurs, thereby blocking battery operation and suppressing a rapid increase in current. The metal layer may include, for example, indium (In), copper (Cu), magnesium (Mg), stainless steel, titanium (Ti), iron (Fe), cobalt (Co), nickel (Ni), zinc (Zn), aluminum (Al), germanium (Ge), or an alloy thereof. The metal layer may act as an electrochemical fuse and may be cut in case of overcurrent to prevent short circuits. The limit current and maximum current may be controlled by adjusting the thickness of the metal layer. The metal layer may be plated or deposited onto the base film. As the thickness of the metal layer decreases, the limit current and/or maximum current of the cathode current collector 11 may be decreased, and thus the stability of the lithium battery during a short circuit may be improved. A lead tab may be added onto the metal layer for external connection. The lead tab may be welded onto the metal layer or the metal layer/base film laminate by ultrasonic welding, laser welding, spot welding, or the like. During welding, the base film and/or metal layer may be molten, thereby electrically connecting the metal layer to the lead tab. To make the welding between the metal layer and the lead tab more solid, a metal chip may be added between the metal layer and the lead tab. The metal chip may be a thin piece of the same material as the metal of the metal layer. The metal chip may be, for example, metal foil, metal mesh, or the like. The metal chip may be, for example, aluminum foil, copper foil, SUS foil, or the like. By arranging a metal chip on a metal layer and then welding the metal layer with a lead tab, the lead tab may be welded to a metal chip/metal layer laminate or a metal chip/metal layer/base film laminate. During welding, the base film, metal layer, and/or metal chip may be molten, thereby electrically connecting the metal layer or metal layer/metal chip laminate to the lead tab. A metal chip and/or lead tab may be added onto a portion of the metal layer. The thickness of the base film may be, for example, in a range of about 1 μm to about 50 μm, about 1.5 μm to about 50 μm, about 1.5 μm to about 40 μm, or about 1 μm to about 30 μm. When the thickness of the base film is within the ranges above, the weight of an electrode assembly may be further effectively reduced. A melting point of the base film may be, for example, in a range of about 100° C. to about 300° C., about 100° C. to about 250° C. or less, or about 100° C. to about 200° C. When the melting point of the base film is within the ranges above, the base film may be molten and easily bonded to the lead tab during the process of welding the lead tab. A surface treatment, such as a corona treatment, may be performed on the base film to improve adhesion between the base film and the metal layer. The thickness of the metal layer may be, for example, in a range of about 0.01 μm to about 3 μm, about 0.1 μm to about 3 μm, about 0.1 μm to about 2 μm, or about 0.1 μm to about 1 μm. When the thickness of the metal layer is within the ranges above, the stability of the electrode assembly may be secured while maintaining conductivity. The thickness of the metal chip may be, for example, in a range of about 2 μm to about 10 μm, about 2 μm to about 7 μm, or about 4 μm to about 6 μm. When the thickness of the metal chip is within the ranges above, the connection between the metal layer and the lead tab may be performed more easily. When the cathode current collector 11 has this structure, the weight of the cathode may be reduced, and as a result, the energy density of the cathode and lithium battery may be improved.

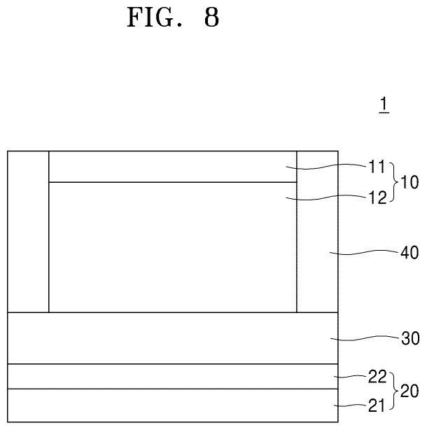

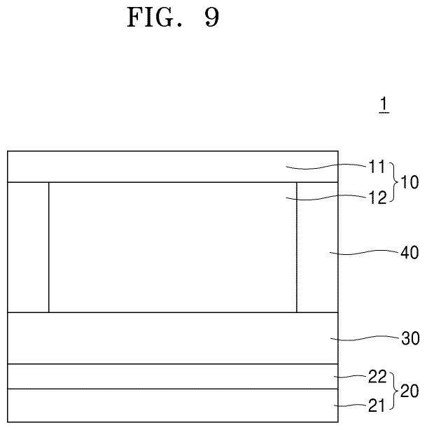

Referring to FIGS. 8 and 9, the cathode 10 may include a cathode current collector 11 and a cathode active material layer 12 arranged on a side of the cathode current collector. An inactive member 40 may be arranged on a side of the cathode 10. Referring to FIG. 8, an inactive member 40 may be arranged on an opposite side of the cathode 10. Referring to FIG. 9, an inactive member 40 may be arranged on both sides of a cathode active material layer 12 and may be placed between an electrolyte layer 30 and a cathode current collector 11 facing the electrolyte layer 30. The inactive member 40 may not arranged on one side of the cathode current collector 11 (not shown). The electrolyte layer 30 may be, for example, a solid electrolyte layer.

By including an inactive member 40, cracking of the electrolyte layer 30 may be prevented when manufacturing an all-solid-state secondary battery 1 and/or during charging and discharging, resulting in improved cycle characteristics of the all-solid-state secondary battery 1. In an all-solid-state secondary battery 1 that does not include an inactive member 40, when manufacturing the all-solid-state secondary battery 1 and/or during charging and discharging, a non-uniform pressure may be applied to the electrolyte layer 30 in contact with the cathode 10, thereby increasing he possibility of a short circuit occurring due to cracks occurring in the electrolyte layer 30 and the growth of lithium metal through the cracks.

In an all-solid-state secondary battery 1, the thickness of the inactive member 40 may be greater than or equal to the thickness of the cathode active material layer 12. Alternatively, in the all-solid-state secondary battery 1, the thickness of the inactive member 40 may be substantially the same as the thickness of the cathode 10. When the thickness of the inactive member 40 is the same as the thickness of the cathode 10, a uniform pressure may be applied between the cathode 10 and the electrolyte layer 30, and the cathode 10 and the electrolyte layer 30 may be sufficiently in close contact with each other, so that the interfacial resistance between the cathode 10 and the electrolyte layer 30 may be reduced. In addition, when the electrolyte layer 30 is sufficiently sintered during a process of preparing the all-solid-state secondary battery 1 under pressure, the internal resistance of the electrolyte layer 30 and the all-solid-state secondary battery 1 including the same may be reduced.

The inactive member 40 may surround the sides of the cathode 10 and may be in contact with the electrolyte layer 30. When the inactive member 40 surrounds the sides of the cathode 10 and is in contact with the electrolyte layer 30, cracks in the electrolyte layer 30, which may occur due to a pressure difference during the pressing process in the electrolyte layer 30 that is not in contact with the cathode 10, may be effectively suppressed. The inactive member 40 may surround the sides of the cathode 10 and may be separated from the anode 20, more specifically, the first anode active material layer 22. The inactive member 40 may surround the sides of the cathode 10, may be in contact with the electrolyte layer 30, and may be separated from the anode 20. Accordingly, the possibility of a short circuit occurring due to physical contact between the cathode 10 and the first anode active material layer 22 or due to overcharging of lithium may be suppressed. For example, by arranging an inactive member 40 on one or both sides of the cathode active material layer 12 and at the same time on one side of the cathode current collector 11, the possibility of a short circuit occurring due to contact between the cathode current collector 11 and the anode 20 may be more effectively suppressed.

Referring to FIGS. 8 to 9, the inactive member 40 may extend from one side of the cathode 10 to the end of the electrolyte layer 30. When the inactive member 40 extends to the end of the electrolyte layer 30, cracks occurring at the end of the electrolyte layer 30 may be suppressed. The end of the electrolyte layer 30 may be the outermost portion that is in contact with the side of the electrolyte layer 30. The inactive member 40 may extend to the outermost portion that is in contact with the side of the electrolyte layer 30. The inactive member 40 may be separated from the anode 20, more specifically, from the first anode active material layer 22. The inactive member 40 may extend to the end of the electrolyte layer 30, but is not in contact with the anode 20. The inactive member 40 may fill a space extending from, for example, one side of the cathode 10 to the end of the electrolyte layer 30.

Referring to FIGS. 8 to 9, a width of the inactive member 40 extending from one side of the cathode 10 to the end of the electrolyte layer 30 may be, for example, in a range of about 1% to about 30%, about 1% to about 25%, about 1% to about 20%, about 1% to about 15%, about 1% to about 10%, or about 1% to about 5% of a width between one side of the cathode 10 and the other side opposite to the one side. When the width of the inactive member 40 is excessively large, the energy density of the all-solid-state secondary battery 1 may be reduced. When the width of the inactive member 40 is excessively small, the effect of arranging the inactive member 40 may be negligible.

The area of the cathode 10 may be small compared to the area of the electrolyte layer 30 in contact with the cathode 10. The inactive member 40 may be arranged surrounding the sides of the cathode 10, thereby compensating for the area difference between the cathode 10 and the electrolyte layer 30. By compensating for the area difference between the cathode 10 and the electrolyte layer 30, the cracking of the electrolyte layer 30 caused by a pressure difference during the pressing process may be effectively suppressed. For example, the sum of the area of the cathode 10 and the area of the inactive member 40 may be equal to the area of the electrolyte layer 30. The electrolyte layer 30 may be, for example, a solid electrolyte layer.

The area of the cathode 10 may be, for example, less than 100%, 99% or less, 98% or less, 97% or less, 96% or less, or 95% or less of the area of the electrolyte layer 30. The area of the cathode 10 may be, for example, in a range of about 50% to about less than 100%, about 50% to about 99%, about 55% to about 98%, about 60% to about 97%, about 70% to about 96%, about 80% to about 95%, or about 85% to about 95% of the area of the electrolyte layer 30.

When the area of the cathode 10 is equal to or larger than the area of the electrolyte layer 30, the possibility of a short circuit occurring due to physical contact between the cathode 10 and the first anode active material layer 22 or due to overcharging of lithium may be increased. The area of the cathode 10 may be, for example, equal to the area of the cathode active material layer 12. The area of the cathode 10 may be, for example, equal to the area of the cathode current collector 11.

The area of the inactive member 40 may be, for example, 50% or less, 40% or less, 30% or less, 20% or less, or 10% or less of the area of the cathode 10. The area of the inactive member 40 may be, for example, in a range of about 1% to about 50%, about 5% to about 40%, about 5% to about 30%, about 5% to about 20%, or about 5% to about 15% of the area of the cathode 10.

The area of the cathode 10 may be smaller than the area of the anode current collector 21. The area of the cathode 10 may be, for example, less than 100%, 99% or less, 98% or less, 97% or less, 96% or less, or 95% or less of the area of the anode current collector 21. The area of the cathode 10 may be, for example, about 50% to about less than 100%, about 50% to about 99%, about 55% to about 98%, about 60% to about 97%, about 70% to about 96%, about 80% to about 95%, or about 85% to about 95% of the area of the anode current collector 21. The area of the anode current collector 21 may be, for example, equal to the area of the anode 20. The area of the anode current collector 21 may be, for example, equal to the area of the first anode active material layer 22.

In the disclosure, “equal” area, length, width, thickness and/or shape may include all instances of having “substantially equal” area, length, width, thickness and/or shape, except where the area, length, width, thickness and/or shape are intentionally different. “Equal” area, length, width and/or thickness may include a range where the unintended difference in the area, length, width and/or thickness of the compared objects may be, for example, less than 3%, less than 2%, less than 1%, less than 0.5%, or less than 0.1%.

The thickness of the inactive member 40 may be, for example, greater than the thickness of the first anode active material layer 22. The thickness of the first anode active material layer 22 may be, for example, 50% or less, 40% or less, 30% or less, 20% or less, or 10% or less of the thickness of the inactive member 40. The thickness of the first anode active material layer 22 may be, for example, in a range of about 1% to about 50%, about 1% to about 40%, about 1% to about 30%, about 1% to about 20%, or about 1% to about 10% of the thickness of the inactive member 40.

The inactive member 40 may be a gasket. When a gasket is used as an inactive member 40, cracks in the electrolyte layer 30 that occur due to a pressure difference during the pressing process may be effectively suppressed.

The inactive member 40 may have, for example, a single-layered structure. Alternatively, although not shown in the drawings, the inactive member 40 may have a multi-layered structure. In the inactive member 40 having a multi-layered structure, each layer may have a different composition. The inactive member having a multi-layered structure may have, for example, a two-layered structure, a three-layered structure, a four-layered structure, or a five-layered structure. The inactive member 40 having a multi-layered structure may include, for example, one or more adhesive layers and one or more support layers. The adhesive layer may effectively prevent, for example, a gap between the cathode 10 and the electrolyte layer 30 due to a change in the volume of the cathode 10 that occurs during the charging and discharging process of an all-solid-state secondary battery 10, and may provide a bonding force between the support layer and other layers, thereby improving the film strength of the inactive member 40. The support layer may provide a supporting force to the inactive member 40, prevent non-uniformity of pressure applied to the electrolyte layer 30 during the pressurizing process or the charging and discharging process, and prevent deformation of an all-solid-state secondary battery 1 being manufactured.

The inactive member 40 may include a flame retardant in the inactive member. When the flame retardant inactive member provides flame retardancy, the possibility of thermal runaway and ignition of an all-solid-state secondary battery 1 may be prevented. As a result, the safety of the all-solid-state secondary battery 1 may be further improved. The flame retardant inactive member may absorb residual moisture within the all-solid-state secondary battery 1, and thus prevent deterioration of the all-solid-state secondary battery 1, thereby improving the lifespan characteristics of the all-solid-state secondary battery 1.

The flame retardant inactive member may include, for example, a matrix and a filler (flame retardant material). The matrix may include, for example, a substrate and a reinforcing material. The matrix may include, for example, a fibrous substrate and a fibrous reinforcing material. When the matrix includes the substrate, the matrix may be elastic. Therefore, the matrix may effectively accommodate the volume change during charging and discharging of an all-solid-state secondary battery and may be arranged in various positions. The substrate included in the matrix may include, for example, a first fibrous material. When the substrate includes the first fibrous material, the volume change of the cathode 10 occurring during the charging and discharging process of an all-solid-state secondary battery 1 may be effectively accommodated, and deformation of the inactive member 40 due to the volume change of the cathode 10 may be effectively suppressed. The first fibrous material may be, for example, a material having an aspect ratio of 5 or more, 20 or more, or 50 or more. The first fibrous material may be, for example, a material having an aspect ratio in a range of about 5 to about 1000, about 20 to about 1000, or about 50 to about 1000. The first fibrous material may be, for example, an insulating material. When the first fibrous material is an insulating material, a short circuit between the cathode 10 and the anode 20 caused by lithium dendrites or the like, which occurs during the charging and discharging process of an all-solid-state secondary battery, may be effectively prevented. The first fibrous material may include one or more selected from, for example, a pulp fiber, an insulating polymer fiber, and an ion-conducting polymer fiber. When the matrix includes a reinforcing material, the strength of the matrix may be improved. Therefore, the matrix may prevent excessive volume change during charging and discharging of an all-solid-state secondary battery and prevent deformation of the all-solid-state secondary battery. The reinforcing material included in the matrix may include, for example, a second fibrous material. When the reinforcing material includes the second fibrous material, the strength of the matrix may be increased more uniformly. The second fibrous material may be, for example, a material having an aspect ratio of 3 or more, 5 or more, or 10 or more. The first fibrous material may be, for example, a material having an aspect ratio in a range of about 3 to about 100, about 5 to about 100, or about 10 to about 100. The second fibrous material may be, for example, a flame retardant material. When the second fibrous material is a flame retardant material, ignition due to thermal runaway that occurs during the charging and discharging process of an all-solid-state secondary battery 1 or due to external impact may be effectively suppressed. The secondary fibrous material may be, for example, a glass fiber, a metal oxide fiber, a ceramic fiber, or the like.

The flame retardant inactive member may include a filler (flame retardant material) in addition to the matrix. The filler may be arranged in the matrix, on the surface of the matrix, or both in and on the surface of the matrix. The filler may be, for example, an inorganic material. The filler included in the flame retardant inactive member may be, for example, a moisture getter. The filler may remove moisture remaining in an all-solid-state secondary battery 1 by, for example, adsorbing moisture at a temperature below 100° C., and thus prevent deterioration of the all-solid-state secondary battery 1. In addition, when the temperature of the all-solid-state secondary battery 1 increases to 150° C. or greater due to thermal runaway that occurs during the charging and discharging process of the all-solid-state secondary battery 1 or due to external impact, the filler may effectively suppress ignition of the all-solid-state secondary battery 1 by releasing adsorbed moisture. That is, the filler may be, for example, a flame retardant. The filler may be, for example, a metal hydroxide having moisture adsorbing properties. The metal hydroxide included in the filler may be, for example, Mg(OH)₂, Fe(OH)₃, Sb(OH)₃, Sn(OH)₄, TI(OH)₃, Zr(OH)₄, Al(OH)₃, or a combination thereof.

The content of the filler included in the flame retardant inactive member may be, for example, in a range of about 10 parts by weight to about 80 parts by weight, about 20 parts by weight to about 80 parts by weight, about 30 parts by weight to about 80 parts by weight, about 40 parts by weight to about 80 parts by weight, about 50 parts by weight to about 80 parts by weight, about 60 parts by weight to about 80 parts by weight, or about 65 parts by weight to about 80 parts by weight, based on 100 parts by weight of the flame retardant inactive member 4.

The flame retardant inactive member may further include, for example, a binder. The binder may include, for example, a curable polymer or a non-curable polymer. The curable polymer may be a polymer which is cured by heat and/or pressure. The curable polymer may be, for example, a solid at room temperature. The flame retardant inactive member 40 may include, for example, a thermo-pressure curable film and/or a cured product thereof. A thermo-pressure curable polymer may be, for example, TSA-66 from Toray.

The flame retardant inactive member may additionally include other materials in addition to the substrate, reinforcing material, filler and binder described above. The flame retardant inactive member may further include one or more selected from, for example, paper, an insulating polymer, an ion-conducting polymer, an insulating inorganic material, an oxide-based solid electrolyte, and a sulfide-based solid electrolyte. The insulating polymer may be an olefinic polymer, such as polypropylene (PP), polyethylene (PE), and the like.

The density of the reinforcing material included in the flame retardant inactive member may be, for example, in a range of about 10% to about 300%, about 10% to about 150%, about 10% to about 140%, about 10% to about 130%, or about 10% to about 120% of the density of the composite cathode active material included in the cathode active material layer 12.

The inactive member 40 may be a member that does not include an electrochemically active material, for example, an electrode active material. The electrode active material may be a material that allows intercalation/deintercalation lithium. The inactive member 40 may be a member consisting of a material other than an electrode active material and used in the art.

The cathode 10 may be manufactured, for example, by a wet process. The cathode may be, for example, manufactured by the following exemplary method, but a method of preparing the cathode is not necessarily limited to the exemplary method and may be adjusted according to required conditions.

First, a cathode active material composition may be prepared by mixing the above-described composite cathode active material, a conductive material, a binder, and a solvent. The prepared cathode active material composition may be directly applied and dried onto an aluminum current collector to manufacture a cathode plate having a cathode active material layer formed thereon. Alternatively, the cathode active material composition may be cast on a separate support, and then a film obtained by peeling off the support may be laminated onto the aluminum current collector to manufacture a cathode plate having a cathode active material layer formed thereon.

According to another embodiment, a lithium secondary battery may include a cathode including the above-described composite cathode active material. When the lithium secondary battery includes the cathode including the above-described composite cathode active material, the capacity of the lithium secondary battery may be improved and the fast-charging characteristics may be improved.

The lithium battery may be, for example, manufactured by the following exemplary method, but a method of manufacturing the lithium battery is not necessarily limited to the exemplified method and may be adjusted according to required conditions.

First, a cathode may be manufactured according to the above-described method of manufacturing the cathode.

Referring to FIGS. 5 to 9, the anode 20 may include a first anode active material layer 22. The first anode active material layer 22 may include, for example, an anode active material and a binder.

The anode active material included in the first anode active material layer 22 may be, for example, an anode material capable of forming an alloy or compound with lithium.

The anode active material included in the first anode active material layer 22 may have, for example, a particle form. The average particle diameter of the anode active material having a particle form may be, for example, 4 μm or less, 3 μm or less, 2 μm or less, 1 μm or less, 500 nm or less, 300 nm or less, or 100 nm or less. The average particle diameter of the anode active material having a particle form may be, for example, in a range of about 10 nm to about 4 μm, about 10 nm to about 3 μm, about 10 nm to about 2 μm, about 10 nm to about 1 μm, about 10 nm to about 500 nm, about 10 nm to about 300 nm, or about 10 nm to about 100 nm. When the anode active material has an average particle diameter within the ranges above, reversible absorption and/or desorption of lithium may be facilitated during charging and discharging. The average particle diameter of the anode active material may be, for example, a median diameter (D50) measured by using a laser particle size distribution meter.

The anode active material included in the first anode active material layer 22 may include, for example, one or more selected from a carbon-based anode active material and a metal or metalloid anode active material.

The carbon-based anode active material may include, for example, amorphous carbon, crystalline carbon, porous carbon, or a combination thereof.

The carbon-based anode material may be particularly amorphous carbon. The amorphous carbon may include, but is not limited to, carbon black (CB), acetylene black (AB), furnace black (FB), Ketjen black (KB), graphene, or the like, and any material classified as amorphous carbon in the art may be used. The amorphous carbon may be carbon that has no crystallinity or very low crystallinity and may be distinguished from crystalline carbon or graphitic carbon.

The carbon-based anode active material may be, for example, porous carbon.

The pore volume contained in the porous carbon may be, for example, in a range of about 0.1 cc/g to about 10.0 cc/g, about 0.5 cc/g to about 5 cc/g, or about 0.1 cc/g to about 1 cc/g. The average pore diameter of the porous carbon may be, for example, in a range of about 1 nm to about 50 nm, about 1 nm to about 30 nm, or about 1 nm to about 10 nm. The BET surface area of the porous carbon may be, for example, in a range of about 100 m²/g to about 3000 m²/g.

The metal or metalloid anode active material may include one or more selected from gold (Au), platinum (Pt), palladium (Pd), silicon (Si), silver (Ag), aluminum (Al), bismuth (Bi), tin (Sn), and zinc (Zn), but is not necessarily limited thereto, and any metal or metalloid anode active material that forms an alloy or compound with lithium in the art may be used. For example, nickel (Ni) may not form an alloy with lithium and may be therefore not a metal anode active material.

The first anode active material layer 22 may include a type of anode active material among these anode active materials or a mixture of a plurality of different anode active materials. For example, the first anode active material layer 22 may include only amorphous carbon, or one or more selected from gold (Au), platinum (Pt), palladium (Pd), silicon (Si), silver (Ag), aluminum (Al), bismuth (Bi), tin (Sn), and zinc (Zn). Alternatively, the first anode active material layer 22 may include a mixture of amorphous carbon and one or more selected from gold (Au), platinum (Pt), palladium (Pd), silicon (Si), silver (Ag), aluminum (Al), bismuth (Bi), tin (Sn), and zinc (Zn). A mixing ratio of the mixture of amorphous carbon and gold or the like, may be, for example, a weight ratio of about 99:1 to about 1:99, about 10:1 to about 1:2, about 5:1 to about 1:1, or about 4:1 to about 2:1 in, but is not necessarily limited to these ranges, and may be selected according to the required characteristics of an all-solid-state secondary battery 1. When the anode active material has this composition, the cycle characteristics of the all-solid-state secondary battery may be further improved.

The anode active material included in the first anode active material layer 22 may include, for example, a mixture of a first particle consisting of amorphous carbon and a second particle consisting of a metal or metalloid. The metal or metalloid may include, for example, gold (Au), platinum (Pt), palladium (Pd), silicon (Si), silver (Ag), aluminum (Al), bismuth (Bi), tin (Sn), zinc (Zn), and the like. Alternatively, the metalloid may be a semiconductor. The content of the second particle may be in a range of about 1 wt % to about 99 wt %, about 1 wt % to about 60 wt %, about 8 wt % to about 60 wt %, about 10 wt % to about 50 wt %, about 15 wt % to about 40 wt %, or about 20 wt % to about 30 wt %, based on the total weight of the mixture. When the content of the second particle is within the ranges above, for example, the cycle characteristics of an all-solid-state secondary battery 1 may be further improved.

Alternatively, the first anode active material layer 22 may include a composite anode active material. The composite anode active material may include, for example, a carbon-based support and a metal-based anode active material supported on the carbon-based support. When the composite anode active material has this structure, the localization of the metal-based anode active material within the first anode active material layer may be prevented and a uniform distribution may be obtained. As a result, the cycle characteristics of the all-solid-state secondary battery 1 including the first anode active material layer 22 may be further improved.

The metal-based anode active material supported on the carbon-based support may include, for example, a metal, a metal oxide, a composite of a metal and a metal oxide, or a combination thereof. The metal may include, for example, gold (Au), platinum (Pt), palladium (Pd), silicon (Si), silver (Ag), aluminum (Al), bismuth (Bi), tin (Sn), tellurium (Te), and zinc (Zn). The metal oxide may include, for example, gold (Au) oxide, platinum (Pt) oxide, palladium (Pd) oxide, silicon (Si) oxide, silver (Ag) oxide, aluminum (Al) oxide, bismuth (Bi) oxide, tin (Sn) oxide, tellurium (Te) oxide, zinc (Zn) oxide, and the like. The metal oxide may include, for example, AuₓO_{y} (where 0<x≤2, and 0<y≤3), PtₓO_{y} (where 0<x≤1, and 0<y≤2), PdₓO_{y} (where 0<x≤1, and 0<y≤1), SiₓO_{y} (where 0<x≤1, and 0<y≤2), AgₓO_{y} (where 0<x≤2, and 0<y≤1), AlₓO_{y} (where 0<x≤2, and 0<y≤3), BiₓO_{y} (where 0<x≤2, and 0<y≤3), SnₓO_{y} (where 0<x≤1, and 0<y≤2), TeₓO_{y} (where 0<x≤1, and 0<y≤3), ZnₓO_{y} (where 0<x≤1, and 0<y≤1), or a combination thereof. The composite of a metal and a metal oxide may include, for example, a composite of Au and AuₓO_{y} (where 0<x≤2, and 0<y≤3), a composite of Pt and PtₓO_{y} (where 0<x≤1, and 0<y≤2), a composite of Pd and PdₓO_{y} (where 0<x≤1, and 0<y≤1), a composite of Si and SiₓO_{y} (where 0<x≤1, and 0<y≤2), a composite of Ag and AgₓO_{y} (where 0<x≤2, and 0<y≤1), a composite of Al and AlₓO_{y} (where 0<x≤2, and 0<y≤3), a composite of Bi and BiₓO_{y} (where 0<x≤2, and 0<y≤3), a composite of Sn and SnₓO_{y} (where 0<x≤1, and 0<y≤2), a composite of Te and TeₓO_{y} (where 0<x≤1, and 0<y≤3), a composite of Zn and ZnₓO_{y} (where 0<x≤1, and 0<y≤1), a combination thereof.

The carbon-based support may be, for example, amorphous carbon. The amorphous carbon may include, but is not limited to, carbon black (CB), acetylene black (AB), furnace black (FB), Ketjen black (KB), graphene, activated carbon, carbon nanofiber (CNF), carbon nanotube (CNT), or the like, and any material classified as amorphous carbon in the art may be used. The amorphous carbon may be carbon that has no crystallinity or very low crystallinity and may be distinguished from crystalline carbon or graphitic carbon. A carbonaceous material may be, for example, a carbon-based anode active material.

The composite anode active material may have, for example, a particle form. The particle diameter of the composite anode active material having a particle form may be, for example, in a range of about 10 nm to about 4 μm, about 10 nm to about 1 μm, about 10 nm to about 500 nm, about 10 nm to about 200 nm, or about 10 nm to about 100 nm. When the particle diameter of the composite anode active material is within the ranges above, reversible absorption and/or desorption of lithium may be facilitated during charging and discharging. The metal-based anode active material supported on the support may have a particle form, for example. The particle diameter of the metal-based anode active material may be, for example, in a range of about 1 nm to about 200 nm, about 1 nm to about 150 nm, about 5 nm to about 100 nm, or about 10 nm to about 50 nm. The carbon-based support may, for example, have a particle form. The particle diameter of the carbon-based support may be, for example, in a range of about 10 nm to about 2 μm, about 10 nm to about 1 μm, about 10 nm to about 500 nm, about 10 nm to about 200 nm, or about 10 nm to about 100 nm. When the particle diameter of the carbon-based support is within the ranges above, the carbon-based support may be more uniformly arranged within the first anode active material layer. The carbon-based support may be, for example, a nanoparticle having a particle diameter of 500 nm or less. The particle diameter of the composite anode active material, the particle diameter of the metal-based anode active material, and the particle diameter of the carbon-based support may each be, for example, an average particle diameter. The average particle diameter may be a median diameter (D50) measured by using, for example, a laser particle size distribution meter. Alternatively, the average particle diameter may be determined automatically by using software, for example from electron microscope image data, or manually by a manual method.

The binder included in the first anode active material layer 22 may be, for example, styrene-butadiene rubber (SBR), polytetrafluoroethylene, polyvinylidene fluoride, polyethylene, vinylidene fluoride/hexafluoropropylene copolymer, polyacrylonitrile, polymethylmethacrylate, or the like, but is not necessarily limited thereto and any binder used in the art may be used. The binder may consist of a single binder or multiple different binders.

When the first anode active material layer 22 includes a binder, the first anode active material layer 22 may be stabilized on the anode current collector 21. In addition, cracks in the first anode active material layer 22 may be suppressed despite of changes in the volume and/or relative position of the first anode active material layer 22 during the charging and discharging process. For example, when the first anode active material layer 22 does not include a binder, it is possible for the first anode active material layer 22 to be easily separated from the anode current collector 21. When the first anode active material layer 22 is detached from the anode current collector 21, the anode current collector 21 may be in contact with the electrolyte layer 30 at the exposed portion of the anode current collector 21, and thus, the possibility of a short circuit occurring may be increased. The first anode active material layer 22 may be manufactured by, for example, applying a slurry in which materials constituting the first anode active material layer 22 are dispersed onto an anode current collector 21 and drying the slurry. When the first anode active material layer 22 includes a binder, stable dispersion of the anode active material in the slurry may be possible. For example, when applying the slurry onto the anode current collector 21 by screen printing, it is possible to suppress clogging of the screen (for example, clogging by aggregates of the anode active material).

The first anode active material layer 22 may further include an additive used in a conventional all-solid-state secondary battery 1, such as a filler, a coating agent, a dispersant, an ion conductivity aid, and the like.

A ratio (B/A) of the initial charge capacity (B) of the first anode active material layer 22 to the initial charge capacity (A) of the cathode active material layer may be in a range of about 0.005 to about 0.45. The initial charge capacity of the cathode active material layer 12 may be determined at the maximum charging voltage vs. Li/Li⁺ from a first open circuit voltage. The initial charge capacity of the first anode active material layer 22 may be determined at 0.01 V vs. Li/Li⁺ from a second open circuit voltage.

The maximum charging voltage may be determined according to the type of a composite cathode active material. The maximum charging voltage may be, for example, 1.5 V, 2.0 V, 2.5 V, 3.0 V, 3.5 V, 4.0 V, 4.2 V, or 4.3 V. For example, the maximum charging voltage of a Li₂S or Li₂S composite may be 2.5 V vs. Li/Li⁺. For example, the maximum charging voltage of a Li₂S or Li₂S composite may be 3.0 V vs. Li/Li⁺. A ratio (B/A) of the initial charge capacity (B) of the first anode active material layer 22 to the initial charge capacity (A) of the cathode active material layer may be, for example, in a range of about 0.01 to about 0.3, about 0.01 to about 0.2, or about 0.05 to about 0.1. The initial charge capacity (mAh) of the cathode active material layer 12 may be obtained by multiplying the charge specific capacity (mAh/g) of the composite cathode active material by the mass (g) of the composite cathode active material in the cathode active material layer 12. When several types of a composite cathode active material are used, the charging capacity density is multiplied by the mass for each composite cathode active material, and the sum of these values is the initial charge capacity of the cathode active material layer 12. The initial charge capacity of the first anode active material layer 22 may be also calculated in the same way. The initial charge capacity of the first anode active material layer 22 may be obtained by multiplying the charge specific capacity (mAh/g) of the anode active material by the mass of the anode active material in the first anode active material layer 22. When several types of anode active materials are used, the initial charge capacity of the first anode active material layer 22 may be obtained by calculating a value of charge specific capacity x mass for each anode active material and then adding up the each values. The charge specific capacity of each of the composite cathode active material and the anode active material may be measured by using an all-solid-state half-cell using lithium metal as a counter electrode. The initial charge capacity of each of the cathode active material layer 12 and the first anode active material layer 22 may be directly measured by using an all-solid-state half-cell at a constant current density, for example, 0.1 mA/cm². For the cathode, the measurement may be performed with an operating voltage from a first open circuit voltage (OCV) to a maximum charging voltage, for example, 3.0 V (vs. Li/Li⁺). For the anode, the measurement may be performed with an operating voltage from a second OCV to 0.01 V on the anode, for example lithium metal. For example, an all-solid-state half-cell having a cathode active material layer may be charged with a constant current of 0.1 mA/cm² from a first open circuit voltage to 3.0 V, and an all-solid-state half-cell having a first anode active material layer may be charged with a constant current of 0.1 mA/cm² from a second open circuit voltage to 0.01 V. The current density during constant current charging may be, for example, 0.2 mA/cm² or 0.5 mA/cm². The all-solid-state half-cell having a cathode active material layer may be charged from a first open circuit voltage to, for example, 2.5 V, 2.0 V, 3.5 V, or 4.0 V. The maximum charging voltage of the cathode active material layer may be determined by the maximum voltage of a battery satisfying the safety conditions according to JISC8712:2015 of Japanese Standards Association.

When the initial charge capacity of the first anode active material layer 22 is excessively small, the thickness of the first anode active material layer 22 may be too small, and thus, lithium dendrites formed between the first anode active material layer 22 and the anode current collector 21 during repeated charging and discharging processes may cause the first anode active material layer 22 to collapse, thereby making it difficult to improve the cycle characteristics of the all-solid-state secondary battery 1. When the charge capacity of the first anode active material layer 22 increases excessively, the energy density of the all-solid-state secondary battery 1 may be decreased and the internal resistance of the all-solid-state secondary battery 1 due to the first anode active material layer 22 may be increased, thereby making it difficult to improve the cycle characteristics of the all-solid-state secondary battery 1.

The thickness of the first anode active material layer 22 may be, for example, 50% or less, 40% or less, 30% or less, 20% or less, 10% or less, or 5% or less of the thickness of the cathode active material layer 12. The thickness of the first anode active material layer 22 may be, for example, in a range of about 1% to about 50%, about 1% to about 40%, about 1% to about 30%, about 1% to about 20%, about 1% to about 10%, or about 1% to about 5% of the thickness of the cathode active material layer 12. The thickness of the first anode active material layer 22 may be, for example, in a range of about 1 μm to about 20 μm, about 2 μm to about 15 μm, or about 3 μm to about 10 μm. When the thickness of the first anode active material layer 22 is excessively small, lithium dendrites formed between the first anode active material layer 22 and the anode current collector 21 may cause the first anode active material layer 22 to collapse, thereby making it difficult to improve the cycle characteristics of the all-solid-state secondary battery 1. When the thickness of the first anode active material layer 22 increases excessively, the energy density of the all-solid-state secondary battery 1 may be decreased and the internal resistance of the all-solid-state secondary battery 1 due to the first anode active material layer 22 may be increased, thereby making it difficult to improve the cycle characteristics of the all-solid-state secondary battery 1. When the thickness of the first anode active material layer 22 is decreased, for example, the initial charge capacity of the first anode active material layer 22 may be also decreased.

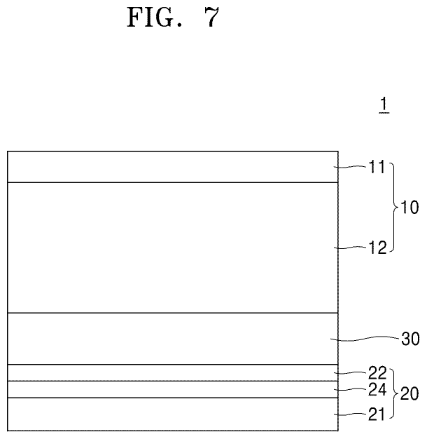

Referring to FIG. 7, the all-solid-state secondary battery 1 may further include, after being charged, a second anode active material layer 24 arranged between, for example, the anode current collector 21 and the first anode active material layer 22. The second anode active material layer 24 may be a metal layer including lithium or a lithium alloy. The metal layer may include lithium or a lithium alloy. Accordingly, the second anode active material layer 24 may be a metal layer including lithium, and thus may function as a lithium reservoir, for example. The lithium alloy may include, but is not limited to, a Li—Al alloy, a Li—Sn alloy, a Li—In alloy, a Li—Ag alloy, a Li—Au alloy, a Li—Zn alloy, a Li—Ge alloy, a Li—Si alloy, and the like, and any lithium alloy used in the art may be used. The second anode active material layer 24 may consist of one of these alloys or lithium, or may consist of several types of alloys. The second anode active material layer 24 may be, for example, a plated layer. The second anode active material layer 24 may be deposited between the first anode active material layer 22 and the anode current collector 21, for example, during the charging process of an all-solid-state secondary battery 1.

The thickness of the second anode active material layer 24 is not particularly limited to, but may be, for example, about 1 μm to about 500 μm, about 1 μm to about 200 μm, about 1 μm to about 150 μm, about 1 μm to about 100 μm, or about 1 μm to about 50 μm. When the thickness of the second anode active material layer 24 is excessively small, it may be difficult for the second anode active material layer 24 to action as a lithium reservoir. When the thickness of the second anode active material layer 24 is excessively large, the mass and volume of an all-solid-state secondary battery 1 may be increased and the cycle characteristics of the all-solid-state secondary battery 1 may actually deteriorate.

Alternatively, in an all-solid-state secondary battery 1, the second anode active material layer 24 may be arranged between an anode current collector 21 and an first anode active material layer 22, for example, before assembling the all-solid-state secondary battery 1. When the second anode active material layer 24 is arranged between the anode current collector 21 and the first anode active material layer 22 before assembling the all-solid-state secondary battery 1, the second anode active material layer 24 may be a metal layer including lithium, and thus may function as a lithium reservoir. For example, a lithium foil may be arranged between the anode current collector 21 and the first anode active material layer 22 before assembling the all-solid-state secondary battery 1.

When the second anode active material layer 24 is deposited by charging after assembling the all-solid-state secondary battery 1, the second anode active material layer 24 may not be included during the assembling of the all-solid-state secondary battery 1, thereby increasing the energy density of the all-solid-state secondary battery 1. When charging an all-solid-state secondary battery 1, the charging may be performed in excess of the charging capacity of a first anode active material layer 22. That is, the first anode active material layer 22 may be overcharged. During the initial stage of charging, lithium may be absorbed into the first anode active material layer 22. The anode active material included in the first anode active material layer 22 may form an alloy or compound with the lithium ions that have moved from the cathode 10. When the charging is performed in excess of the charging capacity of the first anode active material layer 22, for example, lithium may be deposited on the back side of the first anode active material layer 22, that is, between the anode current collector 21 and the first anode active material layer 22, and a metal layer corresponding to the second anode active material layer 24 may be formed by the deposited lithium. The second anode active material layer 24 may be a metal layer mainly composed of lithium (i.e., metallic lithium). These results may be obtained, for example, when the anode active material included in the first anode active material layer 22 includes a material that forms an alloy or compound with lithium. During discharge, lithium in the first anode active material layer 22 and the second anode active material layer 24, i.e., the metal layers, may be ionized and then move toward the cathode 10. Therefore, it is possible to use lithium as an anode active material in an all-solid-state secondary battery 1. In addition, since the first anode active material layer 22 covers the second anode active material layer 24, the first anode active material layer 22 may act as a protective layer for the second anode active material layer 24, i.e., the metal layer, and simultaneously play a role in suppressing the precipitation growth of lithium dendrites. Therefore, short circuit and capacity reduction of the all-solid-state secondary battery 1 may be suppressed, and as a result, the cycle characteristics of the all-solid-state secondary battery 1 may be improved. In addition, when the second anode active material layer 24 is arranged by charging after assembling the all-solid-state secondary battery 1, the anode 20, i.e., the anode current collector 21 and the first anode active material layer 22, and the region therebetween may be a Li-free region that does not include lithium (Li) in the initial state or the completely discharged state of the all-solid-state secondary battery 1.

The anode current collector 21 may be composed of, for example, a material that does not react with lithium, i.e., does not form an alloy or compound. The material constituting the anode current collector 21 may include, but is not necessarily limited to, copper (Cu), stainless steel, titanium (Ti), iron (Fe), cobalt (Co), nickel (Ni), and the like, and any material that may be used as an electrode current collector in the art may be used. The anode current collector 21 may be composed of one of the above-described metals, or may be composed of an alloy of two or more metals or a coating material. The anode current collector 21 may be, for example, in the form of a plate or foil.

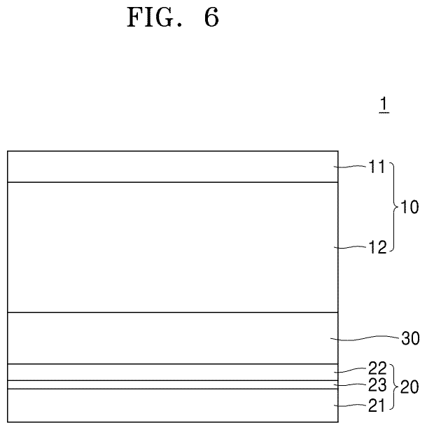

Referring to FIG. 6, the all-solid-state secondary battery 1 may further include a thin film 23 including an element capable of forming an alloy with lithium on one side of the anode current collector 21. The thin film 23 may be arranged between the anode current collector 21 and the first anode active material layer 22. The thin film 23 may include, for example, an element capable of forming an alloy with lithium. The element capable of forming an alloy with lithium may include, but is not necessarily limited to, gold, silver, zinc, tin, indium, silicon, aluminum, bismuth, and the like, and any element capable of forming an alloy with lithium in the art may be used. The thin film 23 may be composed of one of the above-described metals or an alloy of several types of metals. By arranging the thin film 23 on one side of the anode current collector 21, for example, the precipitated shape of the second anode active material layer 24 deposited between the thin film 23 and the first anode active material layer 22 may be further flattened, and the cycle characteristics of the all-solid-state secondary battery 1 may be further improved.

The thickness of the thin film 23 may be, for example, in a range of about 1 nm to about 800 nm, about 10 nm to about 700 nm, about 50 nm to about 600 nm, or about 100 nm to about 500 nm. When the thickness of the thin film 23 is less than 1 nm, it may be difficult for the function of the thin film 23 to be exerted. When the thickness of the thin film 23 is too large, the thin film 23 itself may absorb lithium, which may reduce the amount of lithium deposited from the anode, thereby decreasing the energy density of the all-solid-state battery and deteriorating the cycle characteristics of the all-solid-state secondary battery 1. The thin film 23 may be formed on the anode current collector 21 by, for example, a vacuum deposition method, a sputtering method, a plating method, and the like, but the method is not limited thereto and any method capable of forming a thin film 23 in the art may be used.

Although not shown in the drawings, the anode current collector 21 may include, for example, a base film and a metal layer arranged on one side or both sides of the base film. The base film may comprise, for example, a polymer. The polymer may be, for example, a thermoplastic polymer. The polymer may include, for example, polyethylene terephthalate (PET), polyethylene (PE), polypropylene (PP), polybutylene terephthalate (PBT), polyimide (PI), or a combination thereof. The polymer may be an insulating polymer. When the base film includes an insulating thermoplastic polymer, the base film may soften or be liquefied when a short circuit occurs, thereby blocking battery operation and suppressing a rapid increase in current. The metal layer may include, for example, copper (Cu), stainless steel, titanium (Ti), iron (Fe), cobalt (Co), nickel (Ni), or an alloy thereof. The anode current collector 21 may additionally include a metal chip and/or a lead tab. More details on the base film, metal layer, metal chip, and lead tab of the anode current collector 21 may be the same as described above for the cathode current collector 11. When the anode current collector 21 has this structure, the weight of the anode may be reduced, and as a result, the energy density of the anode and lithium battery may be improved.

Next, a separator to be inserted between the cathode and anode may be prepared.

Any separator commonly used in a lithium battery may be used. For example, a separator is used that has low resistance to ion movement of the electrolyte and excellent electrolyte retention capacity. The separator may be selected from, for example, glass fiber, polyester, Teflon, polyethylene, polypropylene, polytetrafluoroethylene (PTFE), or a combination thereof, and may be in the form of a nonwoven or woven fabric. A rollable separator, such as polyethylene, polypropylene, and the like may be used in a lithium-ion battery and a separator having excellent organic electrolyte impregnation capability may be used in a lithium-ion polymer battery.

The separator may be manufactured by the following exemplary methods, but a method of manufacturing the separator is not necessarily limited to these methods and may be adjusted according to required conditions.

First, a separator composition may be prepared by mixing a polymer resin, a filler, and a solvent. The separator composition may be directly applied and dried onto an electrode to form a separator. Alternatively, the separator composition may be cast and dried on a support, and then a separator film peeled from the support may be laminated on the electrode to form a separator.

The polymer used in manufacturing the separator is not particularly limited, and any polymer used as a binder for the electrode plate may be used. For example, vinylidene fluoride/hexafluoropropylene copolymer, polyvinylidene fluoride (PVDF), polyacrylonitrile, polymethylmethacrylate, or a mixture thereof may be used.

The electrolyte may be, for example, an organic electrolyte. The organic electrolyte may be manufactured, for example, by dissolving a lithium salt in an organic solvent. Any organic solvent used in the art may be used. The organic solvent may be, for example, propylene carbonate, ethylene carbonate, fluoroethylene carbonate, butylene carbonate, dimethyl carbonate, diethyl carbonate, methylethyl carbonate, methylpropyl carbonate, ethylpropyl carbonate, methylisopropyl carbonate, dipropyl carbonate, dibutyl carbonate, benzonitrile, acetonitrile, tetrahydrofuran, 2-methyltetrahydrofuran, γ-butyrolactone, dioxolane, 4-methyldioxolane, N,N-dimethyl formamide, dimethyl acetamide, dimethyl sulfoxide, dioxane, 1,2-dimethoxyethane, sulfolane, dichloroethane, chlorobenzene, nitrobenzene, diethylene glycol, dimethylether, or a mixture thereof.

Any lithium salt used in the art may be used. The lithium salt may be, for example, LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (wherein x and y are each a natural number of 1 to 20), LiCl, LiI, or a mixture thereof.

Referring to FIGS. 5 to 9, the electrolyte layer 30 may include an electrolyte arranged between the cathode 10 and the anode 20. The electrolyte may include, for example, a solid electrolyte, a gel electrolyte, or a combination thereof.

The solid electrolyte may include, for example, a sulfide-based solid electrolyte, an oxide-based solid electrolyte, a polymer solid electrolyte, or a combination thereof.

The solid electrolyte may be, for example, a sulfide-based solid electrolyte. The sulfide-based solid electrolyte may be one or more selected from, for example, Li₂S—P₂S₅, Li₂S—P₂S₅—LiX, where X is a halogen element, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ, where m and n are each a positive number and Z is one of Ge, Zn, or Ga, Li₂S—GeS₂, Li₂S—SiS₂—Li₃PO₄, Li₂S—SiS₂-LiₚMO_{q}, where p and q are each a positive number and M is one of P, Si, Ge, B, Al, Ga, and In, Li₇₋ₓPS₆₋ₓClₓ, where 0≤x≤2, Li₇₋ₓPS₆₋ₓBrₓ, where 0≤x≤2, and Li₇₋ₓPS₆₋ₓIₓ, where 0≤x≤2. The sulfide-based solid electrolyte may be manufactured by subjecting starting materials such as Li₂S, P₂S₅, and the like to a melting-quenching process or a mechanical milling process. Additionally, after this treatment, heat treatment may be performed. The solid electrolyte may be amorphous, crystalline, or a mixed state thereof. In addition, the solid electrolyte may be, for example, those including at least sulfur (S), phosphorus (P), and lithium (Li) as constituent elements among the above-described sulfide-based solid electrolyte materials. For example, the solid electrolyte may be a material including Li₂S—P₂S₅. When using those including Li₂S—P₂S₅ as a sulfide-based solid electrolyte material to form a solid electrolyte, Li₂S and P₂S₅ may be mixed, for example, at a molar ratio of about 20:80 to about 90:10, about 25:75 to about 90:10, about 30:70 to about 70:30, about 40:60 to about 60:40 of Li₂S:P₂S₅.

The sulfide-based solid electrolyte may include, for example, an Argyrodite-type solid electrolyte represented by Formula 1:

Li⁺₁₂₋ₙ₋ₓAⁿ⁺X²⁻₆₋ₓYₓ Formula 1

wherein, in Formula 1, A may be P, As, Ge, Ga, Sb, Si, Sn, Al, In, Ti, V, Nb, or Ta, X may be S, Se, or Te, Y may be Cl, Br, I, F, CN, OCN, SCN, or N₃, 1≤n≤5, and 0≤x≤2. The sulfide-based solid electrolyte may be, for example, an Argyrodite-type compound including one or more selected from Li₇₋ₓPS₆₋ₓClₓ, where 0≤x≤2, Li₇₋ₓPS₆₋ₓBrₓ, where 0≤x≤2, and Li₇₋ₓPS₆₋ₓIₓ, where 0≤x≤2. The sulfide-based solid electrolyte may be, for example, an Argyrodite-type compound including one or more selected from Li₆PS₅Cl, Li₆PS₅Br, and Li₆PS₅I.

The density of the Argyrodite-type solid electrolyte may be in a range of 1.5 g/cc to 2.0 g/cc. When the Argyrodite-type solid electrolyte has a density of 1.5 g/cc or more, the internal resistance of an all-solid-state secondary battery may be reduced, and penetration of the electrolyte layer by Li may be effectively suppressed.

The oxide-based solid electrolyte may be, for example, Li_{1+x+y}AlₓTi₂₋ₓSi_{y}P_{3-y}O₁₂ (where 0<x<2 and 0≤y<3), BaTiO₃, Pb(Zr,Ti)G₃(PZT), Pb₁₋ₓLaₓZr_{1-y} Ti_{y}O₃(PLZT) (where 0≤x<1 and 0≤y<1), PB(Mg₃Nb_{2/3})G₃-PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (where 0<x<2 and 0<y<3), LiₓAl_{y}Ti_{z}(PO₄)₃ (where 0<x<2, 0<y<1, and 0<z<3), Li_{1+x+y}(Al, Ga)ₓ(Ti, Ge)₂₋ₓSi_{y}P_{3-y}O₁₂ (where 0≤x≤1 and 0≤y≤1), LiₓLa_{y}TiO₃ (where 0<x<2, 0<y<3), Li₂O, LiOH, Li₂CO₃, LiAlO₂, Li₂O—Al₂O₃—SiO₂—P₂O₅—TiO₂—GeO₂, Li₃₊ₓLa₃M₂O₁₂ (where M=Te, Nb, or Zr, and 0≤x≤10), or a combination thereof. The oxide-based solid electrolyte may be manufactured, for example, by a sintering method.

The oxide-based solid electrolyte may be, for example, a Garnet-type solid electrolyte selected from Li₇La₃Zr₂O₁₂ (LLZO) and Li₃₊ₓLa₃Zr₂₋ₐMₐO₁₂ (M doped LLZO, where M=Ga, W, Nb, Ta, or Al, 0<a<2, and 0≤x≤10). The polymer solid electrolyte may include a mixture of a lithium salt and a polymer, or may include a polymer having ion-conducting functional groups, for example. The polymer solid electrolyte may be, for example, a polymer electrolyte that is in a solid state at 25° C. and 1 atm. The polymer solid electrolytes may, for example, not contain liquid. The polymer solid electrolyte may include a polymer, and the polymer may be, for example, polyethylene oxide (PEO), polyvinylidene fluoride (PVDF), vinylidene fluoride-hexafluoropropylene (PVDF-HFP), polyethylene oxide (PEO), poly(styrene-b-ethylene oxide) block copolymer (PS-PEO), poly(styrene-butadiene), poly(styrene-isoprene-styrene), poly(styrene-b-divinylbenzene) block copolymer, poly(styrene-ethylene oxide-styrene) block copolymer, polystyrene sulfonate (PSS), polyvinyl fluoride (PVF), poly(methylmethacrylate) (PMMA), polyethylene glycol (PEG), polyacrylonitrile (PAN), polytetrafluoroethylene (PTFE), polyethylene dioxythiophene (PEDOT), polypyrrole (PPY), Polyacrylonitrile (PAN), polyaniline, polyacetylene, Nafion, Aquivion, Flemion, Gore, Aciplex, Morgane ADP, sulfonated poly(ether ether ketone) (SPEEK), sulfonated poly(arylene ether ketone ketone sulfone) (SPAEKKS), sulfonated poly(aryl ether ketone (SPAEK), poly[bis(benzimidazobenzisoquinolinones)](SPBIBI), poly(styrene sulfonate) (PSS), lithium 9,10-diphenylanthracene-2-sulfonate (DPASLi⁺), or a combination thereof, but is not limited thereto, and any polymer electrolyte used in the art may be used. Any lithium salt used in the art may be used. The lithium salt may be, for example, LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (where x and y are each 1 to 20), LiCl, LiI, or a mixture thereof. The polymer included in the polymer solid electrolyte may be, for example, a compound including 10 or more, 20 or more, 50 or more, or 100 or more repeating units. The weight average molecular weight of the polymer included in the polymer solid electrolyte may be, for example, 1000 Dalton or more, 10,000 Dalton or more, 100,000 Dalton or more, or 1,000,000 Dalton or more.

The gel electrolyte may be, for example, a polymer gel electrolyte. The gel electrolyte may have a gel state without including a polymer, for example.

The polymer gel electrolyte may include, for example, a liquid electrolyte and a polymer, or an organic solvent and a polymer having ion-conducting functional groups. The polymer gel electrolyte may be, for example, a polymer electrolyte that is in a gel state at 25° C. and 1 atm. The polymer gel electrolyte may have a gel state, for example, without containing liquid. The liquid electrolyte used in the polymer gel electrolyte may be: for example, a mixture of an ionic liquid, a lithium salt, and an organic solvent; a mixture of a lithium salt and an organic solvent; or a mixture of an ionic liquid and an organic solvent. The polymer used in the polymer gel electrolyte may be selected from polymers used in a solid polymer electrolyte. The organic solvent may be selected from organic solvents used in a liquid electrolyte. The lithium salt may be selected from lithium salts used in a polymer solid electrolyte. The ionic liquid refers to a salt in a liquid state at room temperature or a molten state at room temperature, each having a melting point below room temperature and consisting solely of ions. The ionic liquid may include one or more selected from compounds including, for example, a) one or more cations selected from ammonium, pyrrolidinium, pyridinium, pyrimidinium, imidazolium, piperidinium, pyrazolium, oxazolium, pyridazinium, phosphonium, sulfonium, triazolium, and a mixture thereof, and b) one or more anions selected from BF₄⁻, PF₆⁻, AsF₆⁻, SbF₆⁻, AlCl₄⁻, HSO₄⁻, ClO₄⁻, CH₃SO₃⁻, CF₃CO₂⁻, Cl⁻, Br⁻, I⁻, BF₄⁻, SO₄⁻, CF₃SO₃⁻, (FSO₂)₂N⁻, (C₂F₅SO₂)₂N⁻, (C₂F₅SO₂)(CF₃SO₂)N⁻, and (CF₃SO₂)₂N⁻. The polymer solid electrolyte may form a polymer gel electrolyte, for example, by being impregnated into a liquid electrolyte in a secondary battery. The polymer gel electrolyte may further include inorganic particles.

The polymer included in the polymer gel electrolyte may be, for example, a compound including 10 or more, 20 or more, 50 or more, or 100 or more repeating units. The weight average molecular weight of the polymer included in the polymer gel electrolyte may be, for example, 500 Dalton or more, 1000 Dalton or more, 10,000 Dalton or more, 100,000 Dalton or more, or 1,000,000 Dalton or more.

The electrolyte layer 30 may include, for example, a binder. The binder included in the electrolyte layer 30 may be, for example, styrene butadiene rubber (SBR), polytetrafluoroethylene, polyvinylidene fluoride, polyethylene, and the like, but is not limited thereto, and any binder used in the art may be used. The binder of the electrolyte layer 30 may be identical to or different from the binder included in the cathode active material layer 12 and the anode active material layer 22. The binder may be optional.

The content of the binder included in the electrolyte layer 30 may be in a range of about 0.1 wt % to about 10 wt %, about 0.1 wt % to about 5 wt %, about 0.1 wt % to about 3 wt %, about 0.1 wt % to about 1 wt %, 0 wt % to about 0.5 wt %, or 0 wt % to about 0.1 wt %, based on the total weight of the electrolyte layer 30.

The lithium secondary battery may have excellent lifespan characteristics and high rate characteristics, and thus may be used in an electric vehicle (EV), for example. For example, the lithium secondary battery may be used in a hybrid vehicle such as a plug-in hybrid electric vehicle (PHEV) and the like. In addition, the lithium secondary battery may be used in fields that require large amounts of power storage. For example, the lithium secondary battery may be used in an electric bicycle, power tools, and the like.

The lithium battery may be stacked in a plurality of layers to form a battery module, and a plurality of battery modules may form a battery pack. Such a battery pack may be used in any device that requires high capacity and high output. For example, the battery pack may be used in a laptop, a smartphone, an electric vehicle, and the like. The battery module may include, for example, a plurality of batteries and a frame holding the batteries. The battery pack may include, for example, a plurality of battery modules and a bus bar connecting the battery modules. The battery module and/or battery pack may further include a cooling device. A plurality of battery packs may be controlled by a battery management system. The battery management system may include a battery pack and a battery control device connected to the battery pack.

The disclosure will be described in more detail through Examples and Comparative Examples as follows. However, Examples are for illustrating the disclosure only and are not intended to limit the scope of the disclosure.

### PREPARATION OF COMPOSITE CATHODE ACTIVE MATERIAL

### Preparation Example 1: 100 Parts by Weight of NMC+3 Parts by Weight of Mixed Conductor (100 Parts by Weight of Sulfide Solid Electrolyte+0.8 Parts by Weight of CNT 2,000 μm

A composite cathode active material was prepared as follows. First, 100 parts by weight of a sulfide solid electrolyte and 0.8 parts by weight of carbon nanotube (CNT, 2,000 μm) were mixed by using a Resonance Acoustic Mixer (RAM) to prepare a mixed conductor. Second, 100 parts by weight of NMC (LiNi_{0.94}Mn_{0.02}Co_{0.04}O₂) and 3 parts by weight of the prepared mixed conductor were mixed by using the RAM to prepare a composite cathode active material. The CNT 2,000 μm refers to a carbon nanotube having a length of 2,000 micrometers (μm).

### Preparation Example 2: 100 Parts by Weight of NMC+3 Parts by Weight of Mixed Conductor (100 Parts by Weight of Sulfide Solid Electrolyte+2.4 Parts by Weight of CNT 2,000 μm)

100 parts by weight of a sulfide solid electrolyte and 2.4 parts by weight of CNT 2,000 μm were mixed by using a RAM to prepare a mixed conductor. 100 parts by weight of NMC and 3 parts by weight of the prepared mixed conductor were mixed by using the RAM to prepare a composite cathode active material.

### Preparation Example 3: 100 Parts by Weight of NMC+3 Parts by Weight of Mixed Conductor (100 Parts by Weight of Sulfide Solid Electrolyte+4.0 Parts by Weight of CNT 2,000 μm

100 parts by weight of a sulfide solid electrolyte and 4.0 parts by weight of CNT 2,000 μm were mixed by using a RAM to prepare a mixed conductor. 100 parts by weight of NMC and 3 parts by weight of the prepared mixed conductor were mixed by using the RAM to prepare a composite cathode active material.

### Preparation Example 4: 100 Parts by Weight of NMC+3 Parts by Weight of Mixed Conductor (100 Parts by Weight of Sulfide Solid Electrolyte+8.0 Parts by Weight of CNT 2,000 μm

100 parts by weight of a sulfide solid electrolyte and 8.0 parts by weight of 2,000 μm CNT were mixed by using a RAM to prepare a mixed conductor. 100 parts by weight of NMC and 3 parts by weight of the prepared mixed conductor were mixed again by using the RAM to prepare a composite cathode active material.

### Comparative Preparation Example 1: 100 Parts by Weight of NMC+3 Parts by Weight of Sulfide Solid Electrolyte

100 parts by weight of NMC and 3 parts by weight of a sulfide solid electrolyte were mixed by using a RAM to prepare a composite cathode active material.

### Preparation of Lithium Battery (Full Cell)

### Example 1

### Preparation of Cathode

A mixture of the composite cathode active material prepared in Preparation Example 1, a sulfide solid electrolyte, a carbon conductive material, and polyvinylidene fluoride (PVdF) mixed at a weight ratio of 85:13.6:0.8:0.6 was mixed with octyl acetate (OA) to prepare a slurry.

The slurry was applied by a bar coating method onto an aluminum current collector having a thickness of 10 μm, dried at 80° C., dried again under vacuum at 70° C., and then subjected to rolling and punching processes to thereby prepare a cathode having a thickness of 70 μm.

### Manufacture of Pouch Cell

The prepared cathode, an Ag—C composite anode as a counter electrode, and a sulfide solid electrolyte film as both a separator and an electrolyte were used to prepare a pouch cell.

### Examples 2, 3, and 4 and Comparative Example 1

Pouch cells were prepared in the same manner as in Example 1, except that the composite cathode active materials prepared in Preparation Examples 2, 3, and 4, respectively, and Comparative Preparation Example 1 were used instead of the composite cathode active material prepared in Preparation Example 1.

### Evaluation Example 1: SEM Analysis

A scanning electron microscopy analysis was performed on the composite cathode active material prepared in Preparation Example 1. A SEM-EDS analysis was performed by using FEI Titan 80-300 from Philips. The results of the analysis are shown in FIGS. 2, 3, and 4. It was confirmed that the composite cathode active material prepared in Preparation Example 1 includes particles with both a large-diameter lithium metal oxide and particles with a small-diameter lithium metal oxide. Moreover, the surface of each particle was coated with CNT having a length of 2,000 μm.

### Evaluation Example 2: Evaluation of High Temperature and High Rate Characteristics

The lithium batteries manufactured in Example 1 to 4 and Comparative Example 1 were charged in a constant current mode at 45° C. with a current of 0.1 C rate until the voltage reached 4.3 V (vs. Li), and were then cut-off at a current of 0.05 C rate while maintaining the voltage at 4.3 V in a constant voltage mode. Subsequently, the lithium batteries were discharged at a constant current of 0.1 C rate until the voltage reached 2.5 V (vs. Li) during the discharge (a formation cycle).

The lithium batteries that had undergone the formation cycle were charged in a constant current mode at 45° C. with a current of 0.1 C rate until the voltage reached 4.3 V (vs. Li), and were then cut-off at a current of 0.05 C rate while maintaining the voltage at 4.3 V in a constant voltage mode. Subsequently, the lithium batteries were discharged at a constant current of 0.1 C rate until the voltage reached 2.5 V (vs. Li) during the discharge (a 1^{st} cycle).

The lithium batteries that had undergone the 1st cycle were charged in a constant current mode at 45° C. with a current of 0.33 C rate until the voltage reached 4.3 V (vs. Li), and were then cut-off at a current of 0.05 C rate while maintaining the voltage at 4.3 V in a constant voltage mode. Subsequently, the lithium batteries were discharged at a constant current of 0.33 C rate until the voltage reached 2.5 V (vs. Li) during the discharge (a 2nd cycle).

The lithium batteries that had undergone the 2^{nd} cycle were charged in a constant current mode at 0.5 C rate at 45° C. until the voltage reached 4.3 V (vs. Li), and were then cut-off at a current of 0.05 C rate while maintaining the voltage at 4.3 V in a constant voltage mode. Subsequently, the lithium batteries were discharged at a constant current of 0.5 C rate until the voltage reached 2.5 V (vs. Li) during the discharge (a 3^{rd} cycle).

The lithium batteries that had undergone the 3^{rd} cycle were charged in a constant current at 1 C rate at 45° C. until the voltage reached 4.3 V (vs. Li), and were then cut-off at a current of 0.05 C rate while maintaining the voltage at 4.3 V in a constant voltage mode. Subsequently, the lithium batteries were discharged at a constant current of 2 C rate until the voltage reached 1 V (vs. Li) during the discharge (a 4^{th} cycle).

In every charge and discharge cycle, a pause of 10 minutes was allowed after each charge/discharge cycle. The discharge capacity at each cycle was measured and is shown in Table 1.

TABLE 1

| | | Discharge capacity | | | |
|---|---|---|---|---|---|
| | mixed conductor | 0.1 C | 0.33 C | 0.5 C | 1 C |
| Example 1 | 100 parts by weight of sulfide | 213.9 | 193.4 | 183.8 | 151.9 |
| | solid electrolyte + 0.8 parts by | | | | |
| | weight of CNT 2,000 μm | | | | |
| Example 2 | 100 parts by weight of sulfide | 197.5 | 179.2 | 173.5 | 143.9 |
| | solid electrolyte + 2.4 parts by | | | | |
| | weight of CNT 2,000 μm | | | | |
| Example 3 | 100 parts by weight of sulfide | 200.2 | 185.3 | 179.1 | 165.2 |
| | solid electrolyte + 4 parts by | | | | |
| | weight of CNT 2,000 μm | | | | |
| Example 4 | 100 parts by weight of sulfide | 185.5 | 164.5 | 154.7 | 116.8 |
| | solid electrolyte + 8 parts by | | | | |
| | weight of CNT 2,000 μm | | | | |
| Comparative | sulfide solid electrolyte | 189.8 | 162.1 | 144.0 | 66.8 |
| Example 1 | | | | | |

As shown in Table 1, the lithium secondary battery of Example 1 to 4 has improved discharge capacity and high rate characteristics compared to the lithium secondary battery of Comparative Example 1.

According to one aspect, the composite cathode active material may include a linear carbon-based material having a length of 1,000 μm or more and a solid electrolyte in the same coating layer on the surface of a lithium transition metal oxide, thereby improving the electronic conductivity and ion conductivity of the composite cathode active material.

In the composite cathode active material, the movement of electrons and ions between particles may be improved, and thus a lithium secondary battery including the composite cathode active material may not only have an increased capacity, but also have improved fast charging characteristics and high efficiency characteristics.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A composite cathode active material comprising
a plurality of particles, the particles comprising a lithium transition metal oxide, and a coating layer arranged on at least a portion of a surface of the particles,
wherein the coating layer comprises a linear carbon-based material and a solid electrolyte, and a length of the linear carbon-based material is 1,000 μm or more.

2. The composite cathode active material of claim 1,
wherein a diameter of the linear carbon-based material is in a range of about 50 nm to about 100 nm.

3. The composite cathode active material of claim 1,
wherein the linear carbon-based material is a single-walled carbon nanotube (SWCNT), a double-walled carbon nanotube (DWCNT), a multi-walled carbon nanotube (MWCNT), or a combination thereof.

4. The composite cathode active material 1,
wherein the solid electrolyte is a sulfide-based solid electrolyte, and
the sulfide-based solid electrolyte is one or more selected from Li₂S—P₂S₅, Li₂S—P₂S₅—LiX, where X is a halogen element, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ, where m and n are each a positive number, and Z is one of Ge, Zn, and Ga, Li₂S—GeS₂, Li₂S—SiS₂—Li₃PO₄, Li₂S—SiS₂-LiₚMO_{q}, where p and q are each a positive number, and M is one of P, Si, Ge, B, Al, Ga, and In, Li₇₋ₓPS₆₋ₓClₓ, where 0≤x≤2, Li₇₋ₓPS₆₋ₓBrₓ, where 0≤x≤2, and Li₇₋ₓPS₆₋ₓIₓ, where 0≤x≤2.

5. The composite cathode active material of claim 4,
wherein the sulfide-based solid electrolyte comprises an argyrodite-type solid electrolyte, and
the argyrodite-type solid electrolyte comprises one or more selected from Li₆PS₅Cl, Li₆PS₅Br, and Li₆PS₅I.

6. The composite cathode active material of claim 5,
wherein a density of the argyrodite-type solid electrolyte is in a range of about 1.5 g/cc to about 2.0 g/cc.

7. The composite cathode active material of claim 1,
wherein the solid electrolyte has a particle diameter (D50) of 1 μm or less.

8. The composite cathode active material of claim 1,
wherein a sum of a weight of the solid electrolyte and a weight of the linear carbon-based material, based on the total weight of the composite cathode active material is in a range of about 1 wt % to about 20 wt %.

9. The composite cathode active material of claim 1,
wherein a weight ratio of the linear carbon-based material to the solid electrolyte is in a range of about 1:10 to about 10:1.

10. The composite cathode active material of claim 1,
wherein the plurality of particles comprise a first lithium transition metal oxide and a second lithium transition metal oxide,
wherein the first lithium transition metal oxide is a large-diameter lithium transition metal oxide and the second lithium transition metal oxide is a small-diameter lithium transition metal oxide, the first lithium transition metal oxide having a particle diameter greater than the second lithium transition metal oxide.

11. The composite cathode active material of claim 10,
wherein a particle diameter ratio of the first lithium transition metal oxide to the second lithium transition metal oxide is in a range of about 2:1 to about 20:1.

12. The composite cathode active material of claim 10,
wherein the particle diameter of the first lithium transition metal oxide is in a range of about 10 μm to about 20 μm, and the particle diameter of the second lithium transition metal oxide is in a range of about 1 μm to about 5 μm.

13. The composite cathode active material of claim 10,
wherein a weight ratio of the first lithium transition metal oxide to the second lithium transition metal oxide is in a range of about 90:10 to about 60:40, and
a specific surface area of the composite cathode active material is 0.8 m²/g or less.

14. The composite cathode active material of claim 1,
wherein a thickness of the coating layer is in a range of about 0.1 nm to about 1 μm.

15. The composite cathode active material of claim 1,
wherein the coating layer has a single-layered structure, and the coating layer is a dry coating layer.

16. The composite cathode active material of claim 1,
wherein the lithium transition metal oxide is represented by one or more of Formulae 1 to 8:
LiₐCoₓM_{y}O_{2-b}A_{b} Formula 1
wherein, in Formula 1,
1.0≤a≤1.2, 0≤b≤0.2, 0.9≤x≤1, 0≤y<0.1, and x+y=1,
M is manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof, and
A is F, S, Cl, Br, or a combination thereof;
LiₐNiₓCO_{y}M_{z}O_{2-b}A_{b} Formula 2
wherein, in Formula 2,
1.0≤a≤1.2, 0≤b≤0.2, 0.8≤x<1, 0≤y≤0.3, 0<z≤0.3, and x+y+z=1,
M is manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof, and
A is F, S, Cl, Br, or a combination thereof;
LiNiₓCo_{y}Mn_{z}O₂ Formula 3
LiNiₓCo_{y}Al_{z}O₂ Formula 4
wherein, in Formulae 3 and 4, 0.8≤x≤0.95, 0≤y≤0.2, 0<z≤0.2, and x+y+z=1;
LiNiₓCo_{y}Mn_{z}Al_{w}O₂ Formula 5
wherein, in Formula 5, 0.8≤x≤0.95, 0≤y≤0.2, 0<z≤0.2, 0<w≤0.2, and x+y+z+w=1;
LiₐNiₓMn_{y}M′_{z}O_{2-b}A_{b} Formula 6
wherein, in Formula 6,
1.0≤a≤1.2, 0≤b≤0.2, 0<x≤0.3, 0.5≤y<1, 0<z≤0.3, and x+y+z=1, M′ is cobalt (Co), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof, and
A is F, S, Cl, Br, or a combination thereof;
LiₐM1_{xM}2_{y}PO_{4-b}X_{b} Formula 7
wherein, in Formula 7, 0.90≤a≤1.1, 0≤x≤0.9, 0<y<0.5, 0.9<x+y<1.1, and 0≤b≤2, and
M1 is chromium (Cr), manganese (Mn), iron (Fe), cobalt (Co), nickel (Ni), copper (Cu), zirconium (Zr), or a combination thereof,
M2 is magnesium (Mg), calcium (Ca), strontium (Sr), barium (Ba), titanium (Ti), zinc (Zn), boron (B), niobium (Nb), gallium (Ga), indium (In), molybdenum (Mo), tungsten (W), aluminum (Al), silicon (Si), chromium (Cr), vanadium (V), scandium (Sc), yttrium (Y), or a combination thereof, and X is O, F, S, P, or a combination thereof; and
LiₐM3_{z}PO₄ Formula 8
wherein, in Formula 8, 0.90≤a≤1.1 and 0.9≤z≤1.1, and
M3 is chromium (Cr), manganese (Mn), iron (Fe), cobalt (Co), nickel (Ni), copper (Cu), zirconium (Zr), or a combination thereof.

17. A cathode comprising:
a cathode current collector; and
a cathode active material layer arranged on the cathode current collector, the cathode active material layer comprising the composite cathode active material according to claim 1.

18. The cathode of claim 17,
wherein the cathode active material layer further comprises a binder, a conductive material or a combination thereof.

19. A lithium secondary battery comprising:
the cathode of claim 18;
an anode; and
an electrolyte arranged between the cathode and the anode.

20. The lithium secondary battery of claim 19,
wherein the electrolyte is a solid electrolyte.
